(19) United States
(12) Patent Application Publication
(10) Pub. No.: US 2018/0272797 A1
(43) Pub. Date: Sep. 27, 2018

(54) REUSEABLE BODY APPLICATION STENCIL ARRANGEMENT, APPARATUS, AND METHOD OF USE

(71) Applicants: John Brent MÖTTELI, Arbon (CH); Marco ALLENSPACH, Roggwill (CH)

(72) Inventors: Marco ALLENSPACH, Roggwil (CH); John Brent MÖTTELI, Arbon (CH)

(73) Assignee: John Brent MÖTTELI, Arbon (CH)

(21) Appl. No.: 15/928,266

(22) Filed: Mar. 22, 2018

Related U.S. Application Data
(60) Provisional application No. 62/474,647, filed on Mar. 22, 2017.
(60) Provisional application No. 62/482,229, filed on Apr. 6, 2017.
(60) Provisional application No. 62/505,144, filed on May 12, 2017.

(30) Foreign Application Priority Data
Jun. 27, 2017 (EP) 17178209.9
Jun. 28, 2017 (AU) 2017204373

(51) Int. Cl. B44D 2/00; B44C 5/04; B44C 3/08

(52) U.S. Cl. CPC B44D 2/007; B44C 3/087; B44D 2/002; B44C 5/04

(57) ABSTRACT

A system is provided enabling do it yourself body stenciling and/or body art. In particular, the system of the invention provides a body tight removable mask that masks an area of the body for body applications. The mask is sized to fit a particular portion of the torso or an appendage of a subject individual, and masks a standard area to enable an unskilled artisan to treat a portion of the subject individual. The stencil can mask a logo (e.g. of a sports team) or other form such as a swimsuit form on a wrist or ankle or upper torso, forehead, or a bathing suit area of the subject individual. The system optionally includes adhesive, Velcro, or other interlocking overlapping portions enabling easy removal of the stencil without disturbing the freshly treated area. In its simplest form, the stencil is a mask of the thighs, and the waist, the lower chest area and upper chest area, for example, with a preferably elastic mask panel that can be easily removed once the basic application is complete. Advantageously, the invention enables websites that feature body applications, such as websites featuring Sports teams, Universities, Sports Illustrated or Fashion TV, to sell stencil product in association with displays of finished works on models.

### CROSS REFERENCE TO RELATED APPLICATIONS

This application claims the benefit of U.S. Provisional Application No. 62/474,647, filed Mar. 22, 2017, U.S. Provisional Application 62/482,229, filed Apr. 6, 2017, U.S. Provisional Application 62/505,144, filed May 12, 2017, European Application No. EP17178209.9, filed Jun. 27, 2017, and Australian Appl. No. 2017204373, filed Jun. 28, 2017, the contents of the entirety of which are explicitly incorporated herein by reference and relied upon to define features for which protection may be sought hereby as it is believed that the entirety thereof contributes to solving the technical problem underlying the invention, some features that may be mentioned hereunder being of particular importance.

### COPYRIGHT & LEGAL NOTICE

A portion of the disclosure of this patent document contains material which is subject to copyright protection. The Applicant has no objection to the facsimile reproduction by anyone of the patent document or the patent disclosure as it appears in the Patent and Trademark Office patent file or records, but otherwise reserves all copyright rights whatsoever. Further, no references to third party patents or articles made herein is to be construed as an admission that the present invention is not entitled to antedate such material by virtue of prior invention.

### BACKGROUND OF THE INVENTION

This invention relates to stencils for body applications (body painting, latex applications, spray-on clothing, spray-on bandages or temporary skin) on individuals, and in particular, stencils that can be reused on humans, as well as methods of body applications using stencils and systems to facilitate body applications.

Body applications such as body painting, or sometimes bodypainting, is a form of body art. Unlike tattoo and other forms of body art, body painting is temporary, painted onto the human skin, and lasts only for from several hours, to at most (in the case of Mehndi or “henna tattoo”) several weeks. Body painting that is limited to the face is known as face painting. Body painting is also referred to as (a form of) “temporary tattoo”; large scale or full-body painting is more commonly referred to as body painting, while smaller or more detailed work is generally referred to as temporary tattoos.

Body stencils exist and are made up of simple patterns formed in a typically flexible but flat substrate. Such are effective for applying a simple, detail form such as a flower or heart, but are not effective for applying a form that follows the contours of a torso or appendage of a subject individual. These forms are typically much more elaborate and tend to flow from the front of the human torso around the side of the torso and onto the back of the torso.

It is also known to place netting or some other repeating pattern against the body, and paint using the netting as a stencil. Sometimes body netting is donned, then local painting is performed, the netting removed to leave only the repeated patterns (the requirement of removal making netting less appropriate for the application of spray clothing compositions). Sports Illustrated's body painting of model Hanna Ferguson was performed in this way. Inspection of the video of the body painting session makes clear that simple towels or other improvised masks were used to control overspray. The netting patterns itself does not provide any overspray protection to the overall pattern to be painted or applied. Further, when the netting is removed, it is prone to smear the applied paint unless allowed to fully dry.

Although applicable using a brush or similar applicator, body applications are typically performed using an air-brush, a sometimes expensive and rather complicated device that requires connection to a compressed air source. Air brushed body paint or spray clothing applications, as well as that applied via an aerosol container or pump sprayer, generates overspray which can stain adjacent drapes, curtains, or walls. It is therefore not conducive to application indoors, particularly not applicable for application in a hotel room, for example.

Consequently, body applications has generally been limited to the realm of the experienced artisan. This is in part because professional air brushes must be used to obtain clearly defined lines, instead of typical cans of body spray paint. Body paint spray exists but because of the significant overspray, does not provide defined delineations between painted and unpainted or other painted (painted with another color) areas. Because precise demarcation between painted and unpainted or other color painted areas is necessary to create readable designs on an epidermal area, spray cans are typically only used as a background or filler color applied well away from the edges, over which hand painted paints or separate stenciled patterns are optionally applied as well.

Henna based dyes or paintings are utilized to apply various designs to temporarily decorate the epidermis in various cultures, e.g. the Middle Eastern, Indian and North Carican cultures. This is done by applying the paste directly to the epidermis, either free hand or through the use of a stencil. These methods can be difficult to use for the novice. The free hand method takes experience, control, is time consuming and expensive. Stencils can leak and are hard to keep in place.

Mehndi is an art form in which henna based epidermal dye is applied to painting the skin in decorative patterns or pattern designs and has been known for many centuries. This art form is still used primarily in Middle Eastern and Asian cultures before a celebration such as a wedding or a festival. For example, Hindu women have intricate designs applied to their palms and soles of their feet prior to their wedding because, for example, it is believed that the designs enhance fertility and the chance that the young couple will have children. To others, the decorative patterns or pattern designs are aesthetically pleasing and enhances the beauty of the bride. After the henna paste is applied to the skin and allowed to dry, it will painted on the epidermal layer of the skin in direct contrast to a tattoos in which the entire dermis is painted. The epidermis, or outer layer of the skin, naturally sloughs off and takes the Mehndi design with it over time. In effect, the individual has a tattoo that will naturally disappear in one to four weeks depending on a variety of factors. The duration depends on the location of the body to which the painting is applied, the uptake of the paint pigment, and the exposure of the epidermal area to which the paint is applied. For example, the epidermis is thicker on the sole of the foot than on the face, so a Mehndi design that is applied to the sole of the foot will last longer than one that is applied to the face. Further, the Mehndi designs will not last as long when the person having the design constantly washes their hands or other body part, or is exposed to chemicals that remove or dry the epidermis increases sloughing of the skin and correspondingly decreases the duration of the decorative Mehndi painting.

There are a number of undesirable features associated with the application of decorative Mehndi paintings also, as with Western body art. First, having Mehndi and body art applied by a trained artisan is costly. Second, the majority of the public does not have the artisanal training needed to produce a design and have a satisfying result. Third, if the henna paste comes in contact with any exposed skin, then it will leave a mark, even if left on for a brief period of time. Fourth, if the henna past is not of the correct consistency, it will bleed beyond the line drawn and causing widening or blurring of the line that was intended to be drawn by the person applying the painting. Outside of Mehndi paintings, body art painting has grown in popularity with various marketers of goods and promoters of services, such as grand openings of establishments including bars, casinos, hotels and the like in Eastern Europe, as well as for entertainers and dancers where there are theme parties at various night clubs and other venues. Full body art by a professional is both time consuming and entails expense, and requires expertise.

Exemplary art in the area of body/face painting include: U.S. Pat. Nos. 5,836,998, 5,052,418, 5,816269, and 5,479,351; and US Patent Publication Nos. 2009/317774, 2006/1211097, 20001/047951, CA2727849, NL1024119, EP1611815. Similar art that is not for parts of the body below the neck art includes: US Patent Publication No. 2006/121097, 2009/120565, and U.S. Pat. No. 6,289,801. Exemplary art related to sun tanning methods and “paint coated body parts” that are used to producing art on surfaces other than the human body, e.g. a human paint brush, includes: DE20215489, DE3420867, WO2005070386, FR2705616, FR2705615, and US Patent Publication No. 2009/317774.

Spray on clothing (whether latex or cellulose based) does not provide for clean and tailored edges.

In addition, burn victims have sometimes unsightly scares which they may wish to cover up in a quick and comfortable, aesthetically pleasing manner. Custom made skin prostheses made of fabric or latex are expensive and typically not visually pleasing.

What is needed therefore is a system and method enabling inexperienced artisans to apply a standard base color coat to a subject individual on which other patterns and details may optionally be applied so that a very aesthetically pleasing result is obtained.

What is needed therefore is a system and a method enabling medical practitioners to apply temporary bandages or skin quickly and efficiently. Still further, what is needed is a way to do the same that enables the patient to perform the applications without the aid of skilled practitioners.

What is needed is a quick and inexpensive system and method that allows applying a basic form on the torso of an individual in a matter of minutes, not hours.

What is needed is a stencil that can be removed without smearing the already applied, perhaps still wet application material (whether paint or spray clothing compositions).

What is needed is a means of body applications that does not generate unwanted overspray.

What is needed is a means of applying bandages or temporary skin in a quick and inexpensive, as well as aesthetically pleasing manner.

### SUMMARY OF THE INVENTION

In one embodiment, the system of the invention is a body tight removable stencil that masks an area of the body of an individual (a person, herein subsequently referred to as an individual) for body applications. The mask is sized to fit a particular portion of the torso or an appendage of a subject individual, and masks a standard area to enable an unskilled artisan, skilled artisan or a robot to apply a paint or other sprayable composition to a portion of the subject individual. The stencil can mask a logo of a sports team or commercial sponsor, a form on a wrist or ankle or upper torso, forehead, or a bathing suit area of the subject individual. The system optionally includes tape, adhesive, Velcro, or other interlocking overlapping portions (e.g., zipper, clasps, duct tape, etc.) enabling easy removal of the stencil without disturbing the freshly treated area.

In its simplest form, the stencil is a mask of the thighs, and the waist, the lower chest area and upper chest area of a human, for example, with a preferably elastic mask panel that can be easily removed once the basic application or treatment is complete. Advantageously, the invention enables websites that feature body applications, such as Sports teams, Universities, Sports Illustrated or Fashion TV, to sell stencil product in association with displays of body applications, one of the most traffic generating being pictures or videos of body painted models.

In another feature, the mask can be turned inside out and so, if the pattern is asymmetrical, it will mask another area and so allow for applying multiple colors in a checker like manner.

In yet a further variant, the invention provides a body stencil kit comprising the body stencil of any one or more of the elements and features described herein.

In yet a further aspect, the body stencil kit includes the body stencil system, further including at least one body application product (paint or spray clothing composition) and instructions for use.

In a variant, the kit further includes detail stencils for applying further detailing such as flowers or logos over the basic application or over otherwise untreated areas.

In yet another aspect, the invention provides a method for applying a decorative application to the epidermis of a human. The method includes the steps of: applying a stencil having a pattern design delimited thereby around an appendage of a subject individual, masking thereby a predetermined area of the epidermis, the stencil comprising an removable interlocking overlapping panel for enabling easy removal of the stencil, the stencil itself providing an opaque essentially non-absorbent layer which protects the underlying epidermal area from the body application material, defining further an epidermal treatment area; covering the epidermal treatment area and a portion of the non-absorbent layer of the stencil with a predetermined amount of an epidermal application material (such as a body paint or a spray clothing composition such as liquid latex or spray fiber composition) to cause the epidermal application material to contact the epidermis only via the pattern design masked by the stencil; allowing the epidermal paint or spray clothing application to dry, a portion of the epidermal application covering the portion of the epidermis that is coextensive with the pattern design masked by the stencil to form a decorative application in the epidermis in the form of the pattern design; and removing the stencil from the subject individual, thereby leaving the applied pattern design.

In a further variant, the epidermal application material comprises a henna-based die.

In yet a further variant, the invention provides a system for creating body art on an individual, the system that includes a three dimensionally conformable, skin tight mask. The mask includes one or more stencils, each of the stencils comprising a matrix of positioned bridging elements that permit aerosol particulates to deposit below the bridging element onto the skin of the individual. In a variant, the bridging elements are threads or meshes made up of threads. These thread-like bridging elements interfere with the deposition of paint or application material only in a minimal way so as essentially not to perform any masking function.

In one aspect, the bridging elements are selected from the group consisting of bridging elements raised from one or more skin surfaces, and each respective bridging element is connected to at least a first mask and a second mask, and raised from a surface of the skin.

In another aspect, at least of portion of each of the stencils is made from a material that is less flexible than a material from which the remainder of the mask is constructed.

In another variant, the invention provides a kit for creating body art. The kit includes one or more body art spray cans, and one or more skin tight, elastic body art masks. Optionally, each of the respective masks have a first region and a second region, the first region being more elastic than the second region.

In one aspect, the body art masks are constructed to be conformable on the human body in three dimensions, and the kit further comprises body application material (paint or clothing spray compositions), and brushes; make up, and supporting application brushes; costume apparel; hair styling elements, in which the hair styling elements are selected from the group consisting of hair spray, hair colour spray, and a head dress; and/or footwear.

In another variant, the invention provides a mask system for applying body art to an individual. The mask system includes a first removable, substantially skin tight mask and a second removable substantially skin tight mask. Each of the masks have corresponding stencils constructed thereon such that use of the combination of the first mask and the second mask, one after the other, permits the creation of a layered artwork region on the region of the individual's skin. Each of the layered artwork regions includes a substantially finished artwork region after the application of a second layer.

In one aspect, the first mask and the second mask are constructed to be re-useable.

In one embodiment, the invention provides a method of assigning colored body applications, colored panels or T-shirts to individuals attending a concert or sporting event, optionally motivated by discounted tickets to such events, by which a sponsor wishing to communicate a logo or message made up of “pixels” made up of individuals, can do so by a software program which lays out the message in a stadium or concert hall of seats, forms a message, and assigns colors to individuals seating in reserved seats whose location correspond to the location of colored pixels required to form that logo or message. The assignments correspond to tickets for these reserved seats, such tickets prescribing a dominant color, which can be that of a sports team, a sponsor's logo, etc. The apparatus of the invention applies the method and apparatus of the invention to assign a color such as colored applications to the individuals (or fitting them with a colored t-shirt or a panel of) a dominant color according to their reserved seating, thereby creating a sponsor message or logo or other symbol.

These and other objects of the invention are readily apparent in the remainder of the specification including the detailed description, drawings and claims.

### BRIEF DESCRIPTION OF THE DRAWINGS

FIG. 1A is a front view of the system of the invention applied to a subject individual, around the chest.

FIG. 1B is a top view of the mask of the system of FIG. 1A, laid flat.

FIGS. 2A and 2B are three dimensional, perspective views of two mask variants of the invention, which if both used on a subject individual, create an interesting alternating pattern on the individual when two different color or applications, such as color and glitter are used.

FIG. 3 is a front view of the system of the invention applied defining a bikini bottom area for applications, on a subject individual.

FIG. 4 is an example of a bridging element that supports two masks at defined locations with respect to one another while enabling color spraying thereunder.

FIG. 5 is an example of another simple, nylon fishing line bridging element, which at least to a significant extent, allows for applications thereunder or which is sufficiently thin as not to mask any significant portion of the skin thereunder, allowing applications thereunder.

FIG. 6 is a schematic view of a kit of the invention.

FIG. 7A is a front view of the mask in assembled form, mounted on a model or mannequin.

FIG. 7B is a right side view of the mask.

FIG. 7C is a rear view of the mask.

FIG. 7D is a left side view of the mask.

FIG. 7E is a top view of the mask.

FIG. 7F is a rearward top view of the mask.

FIG. 8A is a top view of an upper component of the mask, laid flat.

FIG. 8B is a bottom view of the upper component of the mask, laid flat.

FIG. 9A is a top view of a waist component of the mask, laid flat.

FIG. 9B is a bottom view of the waist component of the mask, laid flat.

FIG. 10A is a top view of a leg component of the mask, laid flat (there are two leg components which are mirror images of each other).

FIG. 10B is a bottom view of the leg component of the mask, laid flat.

FIG. 11 is a perspective view of an automatic applications system of the invention.

FIG. 12A is a side view of the automatic applications system of FIG. 11 in the open position.

FIG. 12B is a side view of the automatic applications system of FIG. 11 in the closed position.

FIG. 13 is a side view of an alternate system which provides more clearances.

FIG. 14A is a partial side view of the stencils wrapped around an individual showing how the stencils cross and overlap in the system of FIGS. 12A, 12B, and 13.

FIG. 14B is a perspective view showing how the stencils cross and overlap.

FIG. 15 is a linkage arrangement that pulls the jaws closed or opened by reacting against one jaw.

FIG. 16A is a simplified embodiment of the invention, in which an individual leans into the stencil.

FIG. 16B is a close up view of the detent mechanism used in the invention.

FIG. 16C is a front view of the alternate embodiment of FIG. 16A.

FIG. 16D is a top view of an alternate embodiment in which stencils may be rolled into place for use including brakes and an interleafing layer to protect against smearing.

FIG. 17 is a perspective view of another variant of the apparatus for in mass production of body painted pattern designs uses a pressure chamber.

FIG. 18A is a perspective view of another variant of the invention.

FIG. 18B is a partial perspective view of a masking form of the variant of FIG. 18A including hinges.

FIG. 19A is a perspective view of still another variant using an application chamber.

FIG. 19B is a cross-sectional side view of the variant of FIG. 19A.

FIG. 20 is a flow chart of a method for the application of a stencil for mass applications.

FIG. 21A is a perspective view of a scanning step and arrangement of the invention.

FIG. 21B is a perspective view of the printing step and arrangement of the invention.

FIG. 21C is a perspective view of a safety support leg of a fixing table of the invention.

FIG. 22 is a flow chart of an alternate method of the invention.

FIG. 23A is a perspective view of a edge cutting arrangement of the invention, including a cutting instrument, for use with spay-on clothing or bandage applications.

FIG. 23B is a cross sectional view of the edge cutting arrangement of FIG. 23A.

FIG. 23C is a side view of an edge cut using the invention of FIG. 23A and fastened into place using glue or another fastening element.

FIG. 23D is a side view of an edge cut using the invention of FIG. 23A fastened using glue but interlaying an elastic element therebetween.

FIG. 23E is a cross-sectional view of an alternate instrument having two rollers.

FIG. 23F is a cross-sectional view of an alternate profile has an edge which curves over the edge of the stencil for ease of manufacturing.

FIG. 24A is a front view of an alternate embodiment of the invention using elastic bands and optionally D-rings and/or buckles and/or tucking of bulky elements.

FIG. 24B is a right (or left if vertically mirrored) side view of the embodiment of FIG. 24A.

FIG. 24C is a rear view of the embodiment of FIG. 24A.

FIG. 24D is a perspective view of the embodiment of FIG. 24A using a D-Ring.

FIG. 24E is a top view of the embodiment of FIG. 24A.

FIG. 25 is a perspective view of the embodiment of FIG. 24A using a bulky element tucked under a strap.

Those skilled in the art will appreciate that elements in the Figures are illustrated for simplicity and clarity and have not necessarily been drawn to scale. For example, dimensions may be exaggerated relative to other elements to help improve understanding of the invention and its embodiments. Furthermore, when the terms ‘first’, ‘second’, and the like are used herein, their use is intended for distinguishing between similar elements and not necessarily for describing a sequential or chronological order. Moreover, relative terms like ‘front’, ‘hack’, ‘top’ and ‘bottom’, and the like in the Description and/or in the claims are not necessarily used for describing exclusive relative position. Those skilled in the art will therefore understand that such terms may be interchangeable with other terms, and that the embodiments described herein are capable of operating in other orientations than those explicitly illustrated or otherwise described.

### DETAILED DESCRIPTION OF THE PREFERRED EMBODIMENT

The following description is not intended to limit the scope of the invention in any way as they are exemplary in nature, serving to describe the best mode of the invention known the inventors as of the filing date hereof. Consequently, changes may be made in the arrangement and/or function of any of the elements described in the exemplary embodiments disclosed herein without departing from the spirit and scope of the invention. In addition, wherever “paint” is used herein, it should be construed as including any coverage or application substance, including injected tattoo dies, capable of covering or impregnating the skin of a subject individual, bandage materials, spray-on fabric or latex, ink jet ink, henna based inks, etc.

The invention is a system, apparatus and method that uses a flexible stencil or stencil system having a delimited pattern design optionally with reinforced edges and/or further optionally with at least one thin strand that stretches across the pattern design to opposite edges thereof. Still further, in another embodiment, the stencil or stencil system has, for at least one component thereof, a readily removable affixation means, enabling removal without disturbing the applied paint.

In one embodiment, the stencil or stencil systems readily delimits a pattern design (which may be made up of several separate masked areas) based on anatomical indicators or anatomical structures which make application of the stencil or stencil system simple and easy for someone having little or no artisanal or artistic skills. Because the stencil or stencil system orients itself on the subject individual based on known anatomical structures of that individual, the final orientation of the masked applications area is defined.

In one embodiment, the stencil is supported by a frame, to effectively mask a pattern design such as a logo, a shape invoking a theme, or an article of clothing, such as a bathing suit, allows applying a stencil to a 3D object and to remove the same without disturbing the applied paint. In another embodiment, the method of the invention applies a pattern design on one or both sides of a subject individual automatically, and which optionally provides a drying step to dry the applied paint before or after removal of the stencil. A further embellishing step may optionally be applied, embellishing the already applied paint with other pattern designs in one or more additional colors in separate applications, to make distinct, multicolour pattern designs.

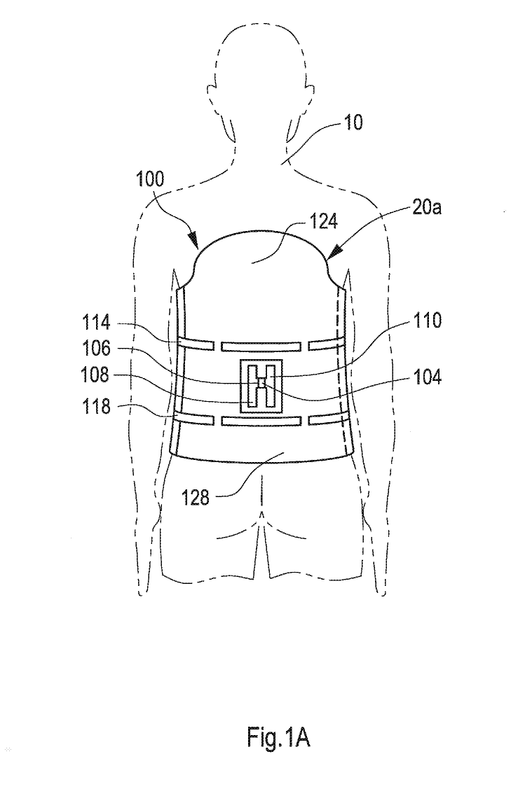

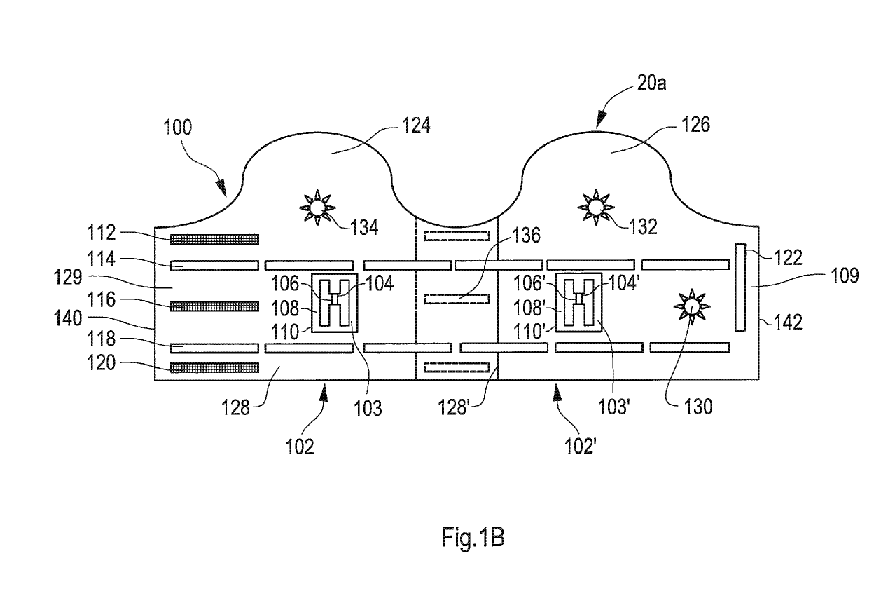

Referring now to FIGS. 1A and 1B, a front view of the system 100 of the invention, made up of at least one flexible panel 102, 102′ or panel combination 20a applied to a subject individual 10, for example, around the chest is shown. At least one panel 102 and/or 102′ includes substantially rigid, less flexible backing material 110 and/or 110′ (in the figure to maintain the shape of the exemplary “H” pattern, such backing material adhered, sewn or otherwise affixed to the panel 102, 102′) to maintain pattern form on application of colour or pigment onto the individual's body using system 100. System 100 further includes upper overspray panel 124, 124′ and lower overspray panel 128, 128′ with one or more intermediate overspray panels 129, 129′ disposed/inserted therebetween. On system 100, thin nylon fish line links 104, 104′, 106, 106′ (of course other polymeric material may be also used in the invention as well as natural, biocompatible materials) are provided to prevent deformation of pattern elements on application, the links are under tension or pressure in a native state and the size and arrangement of the nylon netting is made to mimic the elasticity of the adjacent mask material of which the panel 124 and/or 124′ are made. One or more patterns are provided across the front and back panels of system 100, as indicated by ornamental patterns 108, 108′, 114, 118 on FIG. 1A. It is appreciated that the masks are single use disposable in one variant of the invention, and in another variant of the invention the masks are re-useable. In the context of the masks being re-useable, they are easily cleaned with solvents that are also biocompatible since the sprays used on the human body should be biocompatible so as not to irritate the skin.

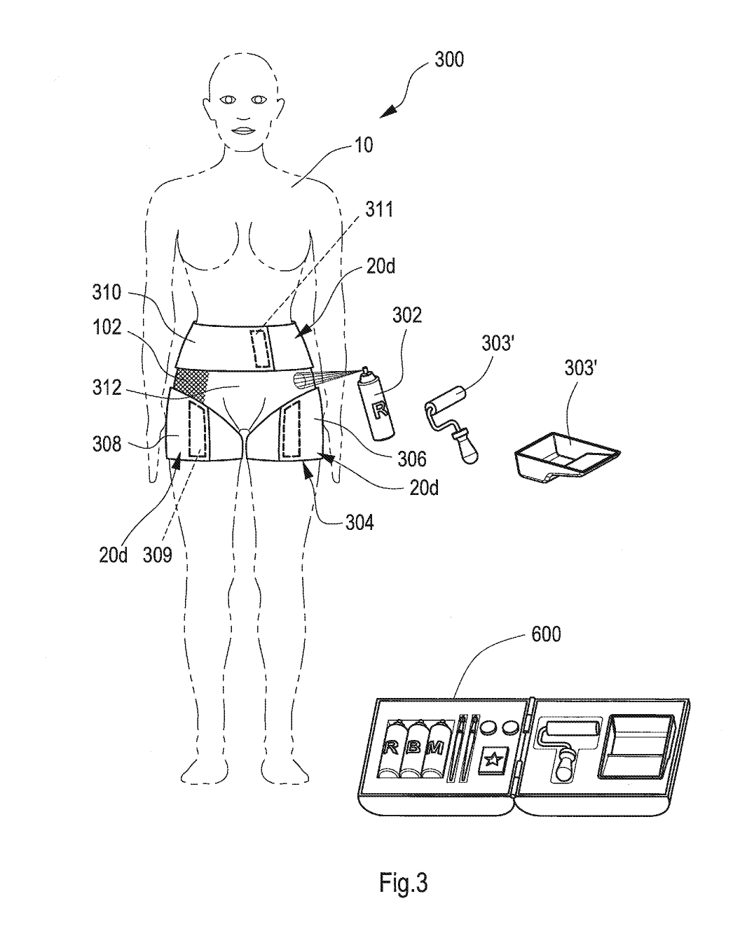

Referring in particular to FIG. 1B, a top view of the mask of the system 100 of FIG. 1A, laid flat, is shown. Again, a plurality of repeating aperture laden patterns 114, 118 are distributed in series across the length of system 100. Similarly, aperture laden patterns 130, 132, 134, 136 have the same or different aperture designs thereon, and are symmetrically or asymmetrically distributed across the front, side and back panel portions of the system 100. It is appreciated that the overspray panels 128, 124, and intervening panels 129, e.g. masks, are made of latex, neoprene, foam rubber, rubber or rubberized material, spandex or other suitable flexible body conforming material. Although the thigh masks 304, 308 (shown for example in FIG. 3) can be made of a closed form which slips over the thigh like a sock as they can typically be removed without disturbing the applied paint, the waist mask 310 should be provided with means of removal without having to pull the waist mask over the top or lower body, in order to prevent disturbing the applied body paint above or below it. In other embodiments, the mask is made of spandex or other stretchable, elastic material. In another embodiment, the mask is made of nylon stocking material. Within the system 100 are subsystems 110, 110′ of various stencils designs. These subsystems 110, 110′ differ in elasticity from the other portions of the masks of the system 100, generally being more rigid, or less flexible while being able to at least partially conform to a portion of the human anatomy while not distorting the pattern design of the stencil and apertures thereof.

A suitable body paint for use in the invention is “Hybrid ProAiir Professional”, UPC 910013529037, available from Glitter-to-Gore dot corn. Another suitable paint is a henna-based die, known in the art. Preferably a UV curable paint is used, such as those described in U.S. Pat. No. 8,815,969 B2, the content of which is incorporated herein by reference. Diluted, gel type UV curable finger nail polish may be another suitable UV curable body paint. To achieve this form of construction, the subsystems include fishnet material 102, through which spray colouring can pass, fish line or thin thread material 104, 104′ 106, 106′ through which colour, e.g. spray can pass underneath, as well as other substantially rigid material 108, 108′, 104′, 106′ (a backing for example, which can be flat but is preferably formed so as to conform to the morphology of the body in that area so as to press against the skin at the edge of the application area) forming the stencil pattern design 108, 108′ and are used to keep various elements of the stencil/mask in orientation to one another permitting the formation of the appropriate design on the skin. The elasticity of the combination of fishnet or thread 104, 106, 104′, 106′ and/or rigid material 110, 110′ is optimally selected to match that of the material of the mask. In the variant of subsystem 110′, fishnet material 103, 103″ (not shown for clarity but filling the pattern H design area) has thin net material and large apertures therebetween so that there is no or very limited interference with the application of body spray paint to the skin is achieved, similarly a network of very thin threads 104, 104′, 106, 106′ are used to hold in various stencil element design elements. On or near a transverse edge 140 of system 100 is located one or more re-openable interlocking fasteners (interlocking strips, zippers, clasps, even tape such as duct tape) which in this embodiment are VELCRO™ brand elements 112, 116, 120 which are spaced horizontally along the panel of system 100 to provide for adjustability of the system to fit more than one size of a human body portion. It is appreciated that the stencil is therefore essentially infinitely adjustable around the torso or waist of a human. Where centering of stencil patterns on the chest and on the back of the individual are preferably centered, then it is best that the stencil be comprised of two elements which interlock around the individual 10, so that the pattern 108, 108′ can be centered front and back essentially regardless of the girth of the individual. This assumes that the overlapping interlocks provide for interlocking over a significant circumferential range. This also help ensure that the stencil will not be significantly circumferentially stretched/deformed, so that the stencil pattern is not significantly deformed. At the opposite end 142 of the system is a mating Velcro fastener(s) 122 to that of fasteners 112, 116, 120 adjacent the first edge 140. The interlocking is preferably made through a Velcro interlock, but other mechanical interlocking means, such as buttons, clasps, clips etc. may be used. Further, adhesive and even magnetic interlocking means may be used to hold the mask in place against the skin. Therefore it should be apparent that a variety of fastener means may be used in the invention.

Note that to accommodate differing girths and size, in order to enter patterns 108, 108′ on the front and rear of the wearer, the mask elements are typically made up of two panels 102, 102′ which interconnect on the right and left sides of the wearer 10, with sufficient interlocking positions to accommodate a wide range of sizes with a single mask combination. For the thigh masks 306, 308, a sufficiently elastic body portion enclosed against itself (that pulls over the appendage like an open sock, wrist band or sweat band) may be used because removal by sliding off the appendage is not likely to disturb applied paint. In other words, elasticity substitutes for the need for an easily removable attachment devices/affixation devices such as a snap or VELCRO™ interlocking straps.

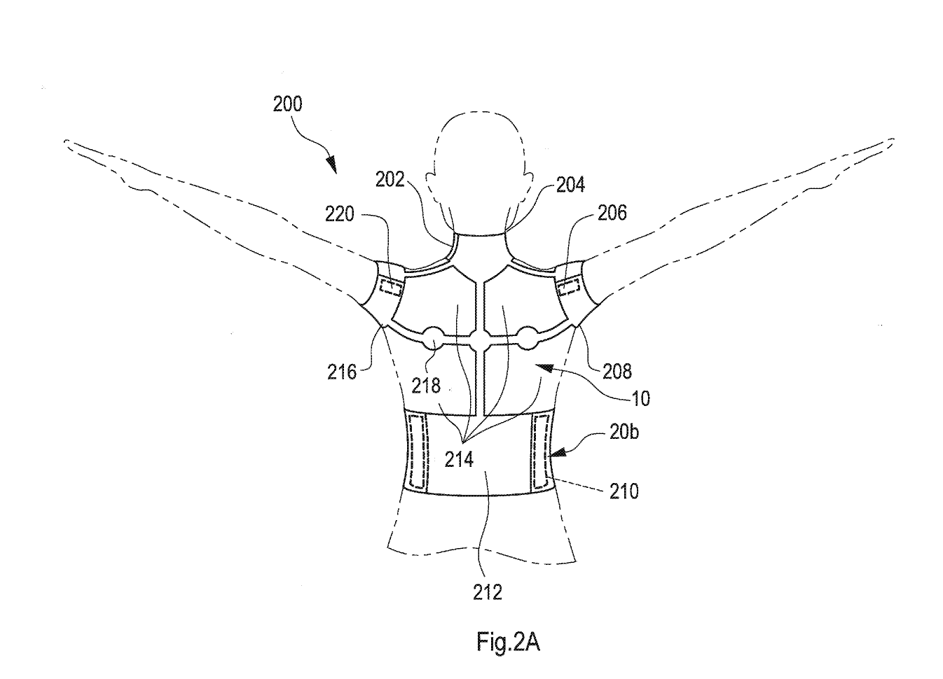

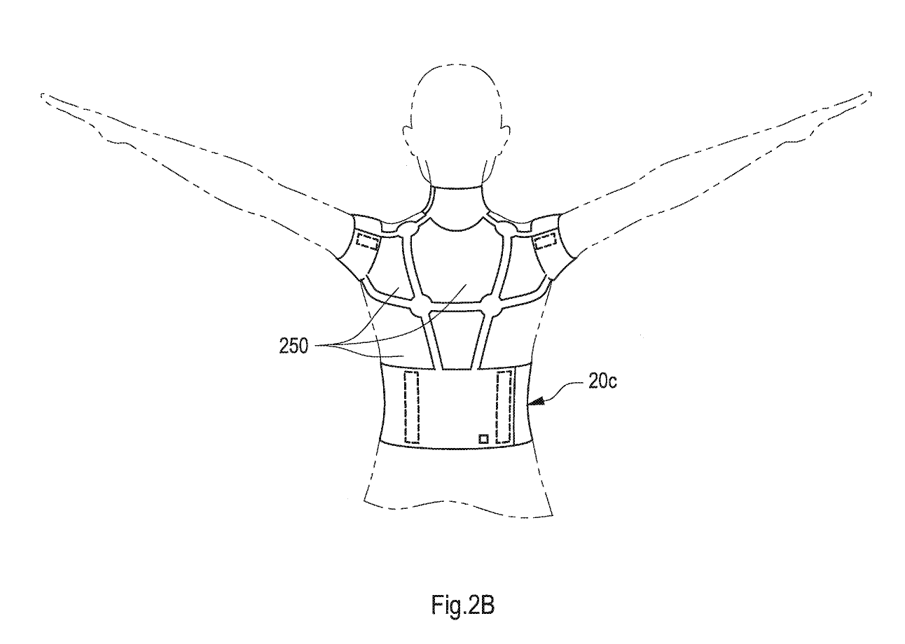

Referring now to FIGS. 2A and 2B, a three dimensional body applications system 200 is shown including a perspective view of two masks 20b and 20c of the invention, which if both are used on a subject individual 10, to create an interesting alternating pattern design on the individual when two different colors and/or applications, such as color and glitter (or other body adorning material) are used. The system 200 includes neck overspray panel 204 which, of course, includes an aperture for the placement of a human neck therein. The panel 204 is fastened around the neck with, for example, VELCRO™ element 202. Similarly, on the left sleeve overspray panel 208 is provided Velcro fastener 206. Chest overspray panel 212 is securely fastened into place around the chest of the user with Velcro fastener 210. Open spray areas 214 are provided as shown. It is appreciated that on system 200, the other stencil sub-systems (special pattern designs 130, 132, 134, less flexible regions, etc.) as shown in FIGS. 1A and 1B are also provided. One or more pattern masks 218 are also optionally provided on system 200. Right sleeve overspray panel 216 is also joined by Velcro fastener 220. In the variant of system 200, in FIG. 2B, spray areas 250 are provided with various patterns being offset. This allows for an overlapping pattern effect and elements thereof to be provided. It is also possible to provide for an overlapping checkered pattern, by way of example.

Referring now to FIG. 3, a front view of the system 300 of the invention is shown. Body spray application material (spray paint, latex, spray clothing compositions) is shown being applied using a stencil arrangement 20d so that it defines a bikini bottom area 312 for applications, on a subject individual 10. System 300 of the invention is sized, dimensioned and constructed with elements illustrated in the figures above, and body art spray can 302 is used in a method of the invention. The system 300 includes a bottom portion 304 that includes a right thigh mask 308 and a left thigh mask 306. For example, right thigh mask 308 is provided with a Velcro fastener to join two ends of the mask. Left thigh mask 306 is provided with a Velcro fastener pair 309 to join two ends of the mask. As already noted, on these left and right thigh masks 306, 308, Velcro fasteners are not strictly required, as a panel closed against itself, like a segment of a sock or leggings, may be used here because there is no risk of smearing the paint when removing the thigh masks. On the other hand, a waist mask 310 is provided with a Velcro or other fastener pair 311 to join two ends of the mask in order to permit removal without smearing the applied paint when the upper body is also being painted (when this is not the case, then the waist mask may be formed similar to the thigh masks as there is no risk of smearing paint).

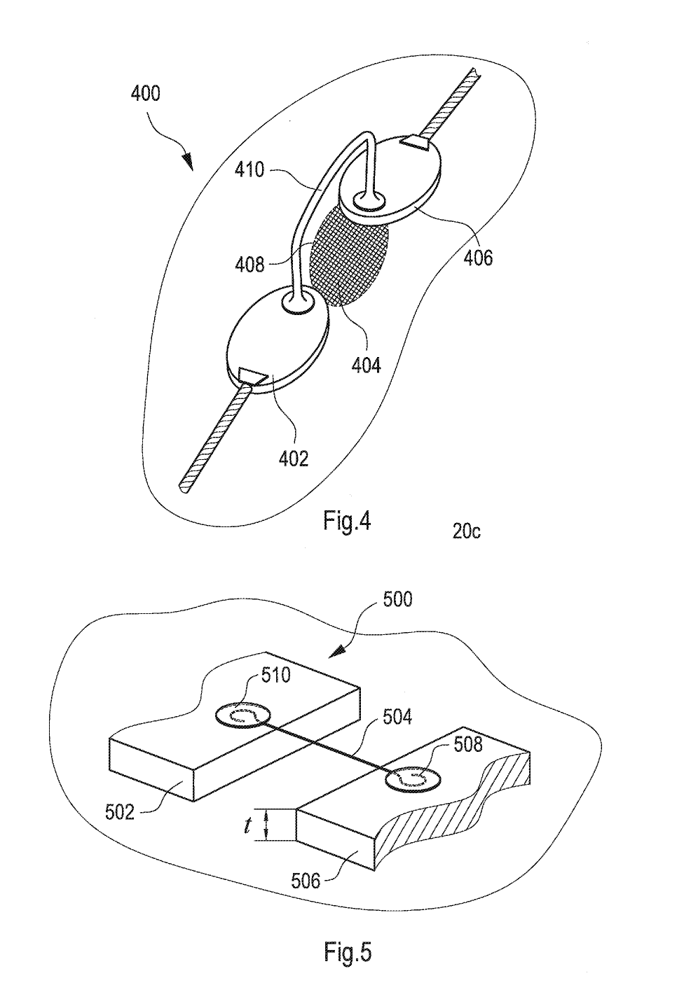

Referring now to FIG. 4, an example of a sub-system 400 bridging element 410 that supports two masks 402, 406 is shown. The masks 402, 406 are disposed at defined locations with respect to one another while enabling color spraying thereunder. In this variant, pattern mask 402 is provided. A raised link 410 connects the pattern mask 402 to pattern mask 406, and therebetween rests region of skin 408 which can be painted, e.g. otherwise it would be masked by the link that connects masks 402, 406. It is appreciated that one or more stencil designs herein utilize one or more or a network of raised (alone or in combination with non-raised bridging elements) bridging elements in a matrix to create very elaborate and detailed stencils on the human body in combinations heretofore unseen by the human eye. The height at which the raised link portion horizontal to the skin is placed varies upon the location at which the sub-system is used. It is appreciated that the height is variable, and can be from a half a millimetre upwards.

Referring now to FIG. 5, an example of sub-system 500 including another simple, nylon fishing line bridging element 504 is shown, which at least to a significant extent, allows for applications thereunder or which is sufficiently thin as not to effectively mask any significant portion of the skin thereunder, allowing applications thereunder. Sub-system 500 includes mask 502 which is connected to mask 506 by bridging element 504. Mask 502 (and other masks) are provided with a thickness of material “t” which raised bridging element 504 sufficiently above the skin so that aerosol spray particulates can be deposited on the skin under bridging element 504. Adhesive pads 508, 510 are used to fix bridging element 504 to the respective masks 502, 506. As with sub-system 400 it is appreciated that one or more sub-systems 500 are used to create one or more stencil designs herein, and utilize one or more or a network of raised (alone or in combination with non-raised bridging elements) bridging elements in a matrix to create very elaborate and detailed stencils on the human body in combinations heretofore unseen by the human eye in a manner that reduces the need for skilled artisanship and decreases time.

It is further appreciated that sub-systems 400, 500 (alone or in combination with other features of the invention) are used alone or in combination. In other variants of the invention, the sub-systems are used in a vertically stacked manner to provide for shading or areas of differing paint particulate deposits on the skin creating an even more detailed stencil design. In other variants, the sub-systems are used in prepositioned locations on the other systems of the invention, e.g. system 100, system 200, system 300, etc. One or more sub-systems are placed in series or parallel along systems 100, 200, 300, in yet further variants of the invention.

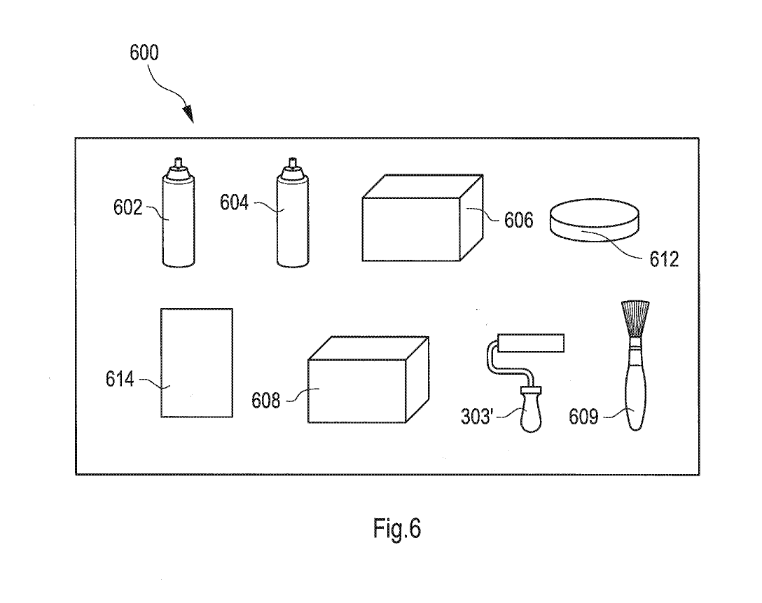

Referring to FIG. 6, a kit 600 is shown, including body paint spray 602, fixing spray 604, one or more individual mask templates 606, 608 for application anywhere on the skin, the 3D masks 610 of the invention, paint roller 303, sponge 307, and/or bushes 609, and instructions for use 614 including video demonstrations on DVD 612, for example. One or more elements of the kit 600 are used, alone or in combination with one or more other elements to form the kit depending on the specific body region that the particular kit is being used for, e.g. torso, waist, bikini area, legs, alone or in combination. Each stencil component may be of a different color to facilitate identification of the component so as to make application quicker and easier. In an embodiment, one or more masks of the invention are made of liquid latex which dries to form a latex layer. In other embodiments, the mask is made of spandex or other stretchable, elastic material such as inexpensive but reusable foam rubber. In another embodiment, the mask is made of nylon stocking material. The interlocking is preferably made through a Velcro interlock, but other mechanical interlocking means, such as buttons, clasps, clips etc. may be used. Further, adhesive and even magnetic means may be used to hold the mask in place against the skin.

In one particularly inexpensive embodiment, the masks are made of thin foam rubber to which self-adhesive Velcro straps are applied. A suitable such Velcro strap is a TESA® hook & loop tape, self-adhesive, UPC code 042448859921, and a suitable foam rubber is GLOREX hobby time, UPC 610877318028. In a further, even less expensive embodiment, the Velcro straps can be replaced with duct tape. The duct tape may simply cut to release, and new tape may be applied for the subsequent use.

It is further appreciated that kit 600 can include other elements to help round out the image or character created by the body art of the human. It is appreciated that this kit 600 is particularly useful during festivals, e.g. Carnival in Brazil, and in other countries, as well as, a myriad of other events and festivals. With that in mind, the kit further optionally includes body application material, and brushes; make up, and supporting application brushes, costume apparel, hair styling elements, in which the hair styling elements are selected from the group consisting of hair spray, hair colour spray, and a head dress, and footwear.

It should be also appreciated that the invention can be used in a process by which the stencil pattern is uploaded via the internet by the individual, and the system then manages the custom cutting (water or laser cutting for example) of the particular stencil pattern, along with other production, ancillary promotional, packaging, and mailing steps. The individual can also order any desired hair and body paint colors or glitter, to complete a desired order.

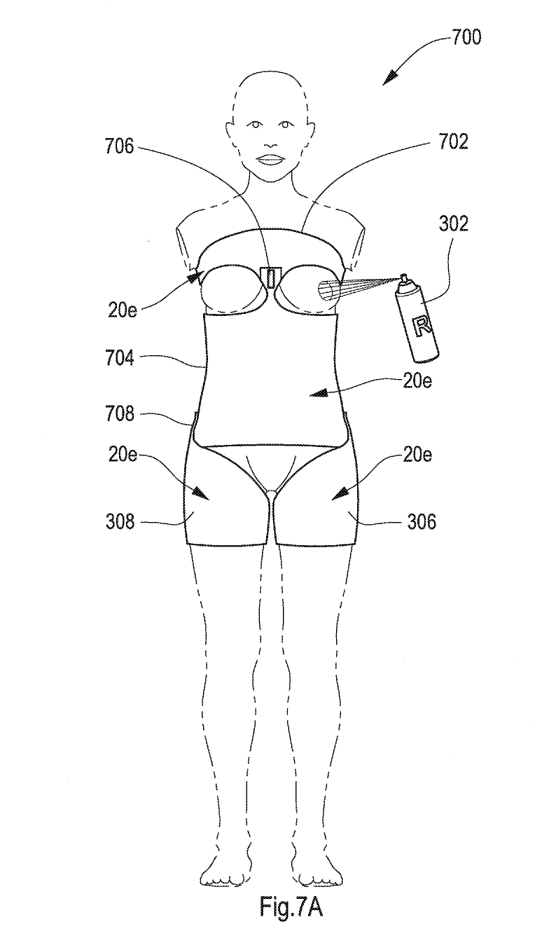

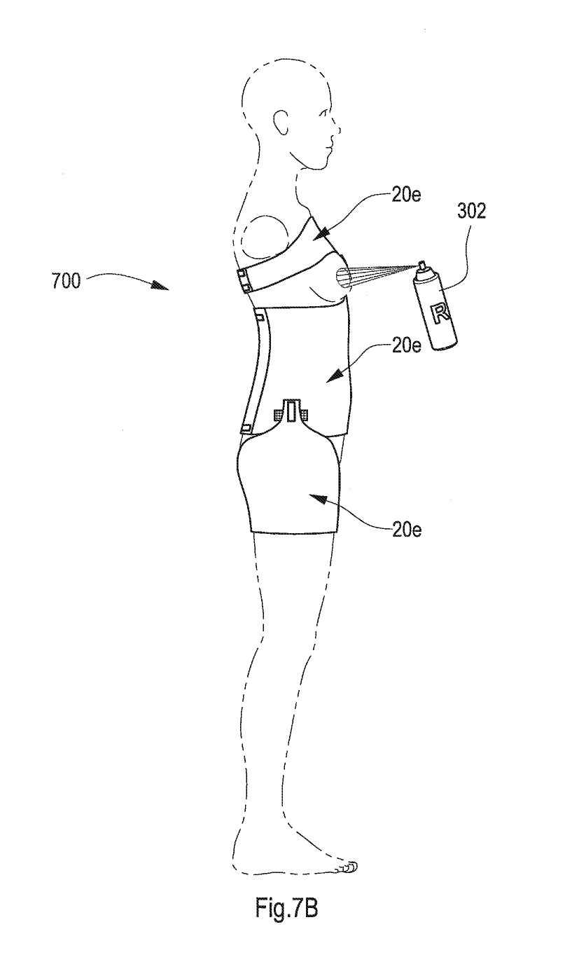

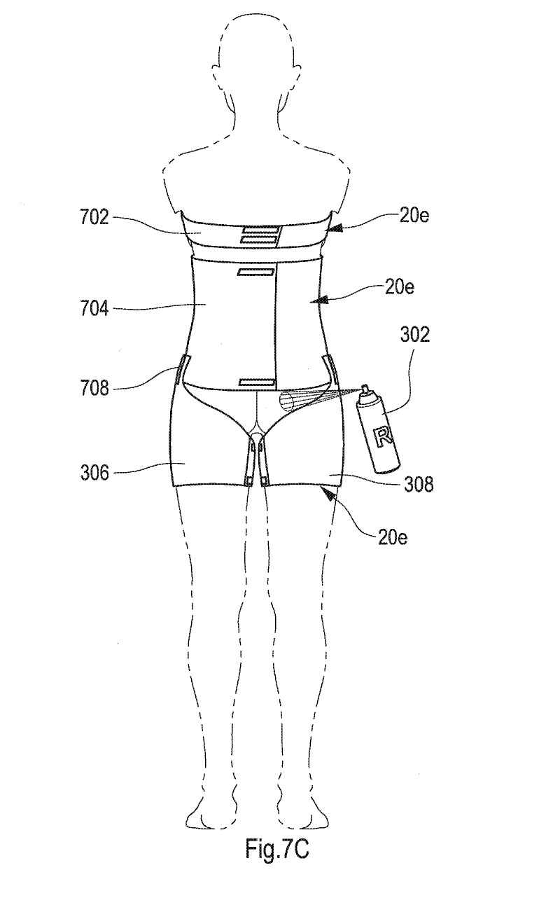

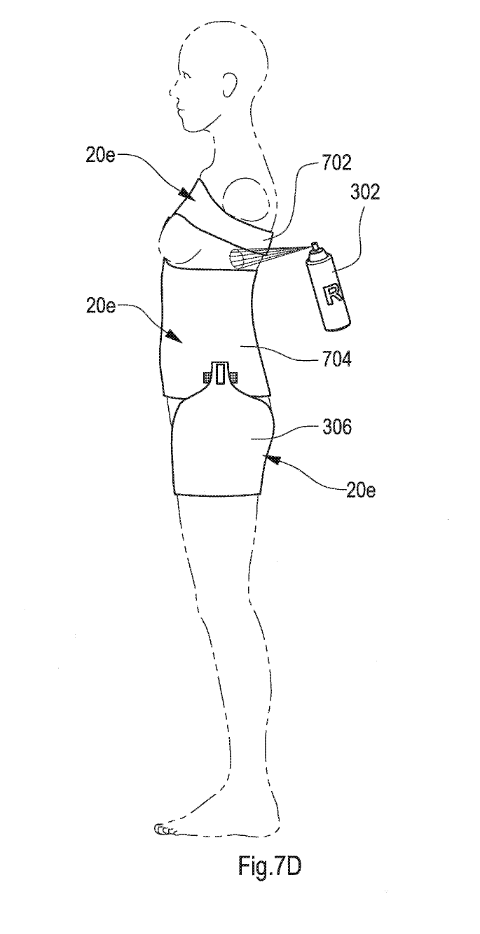

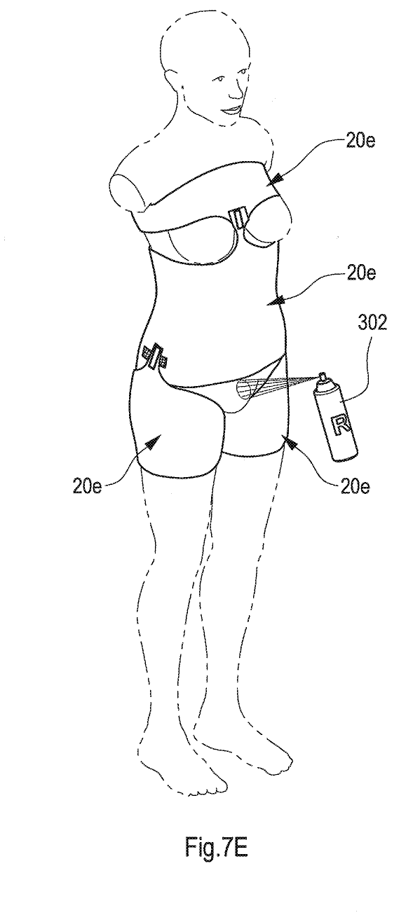

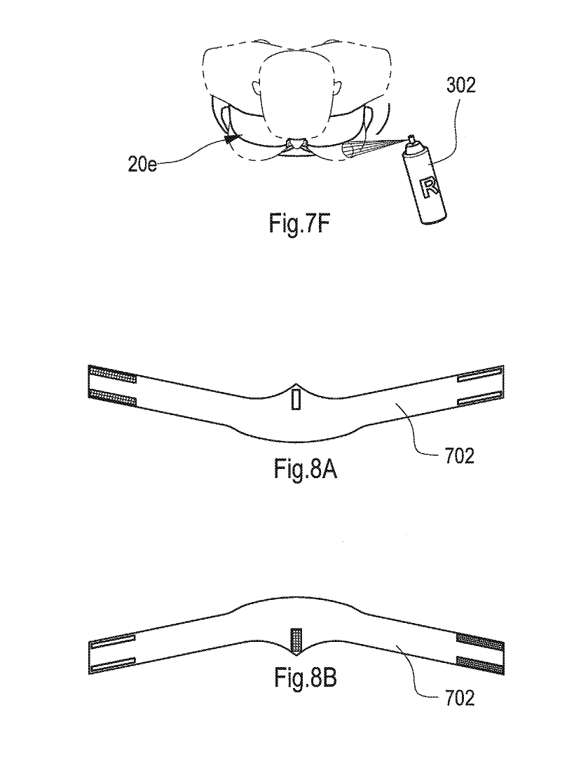

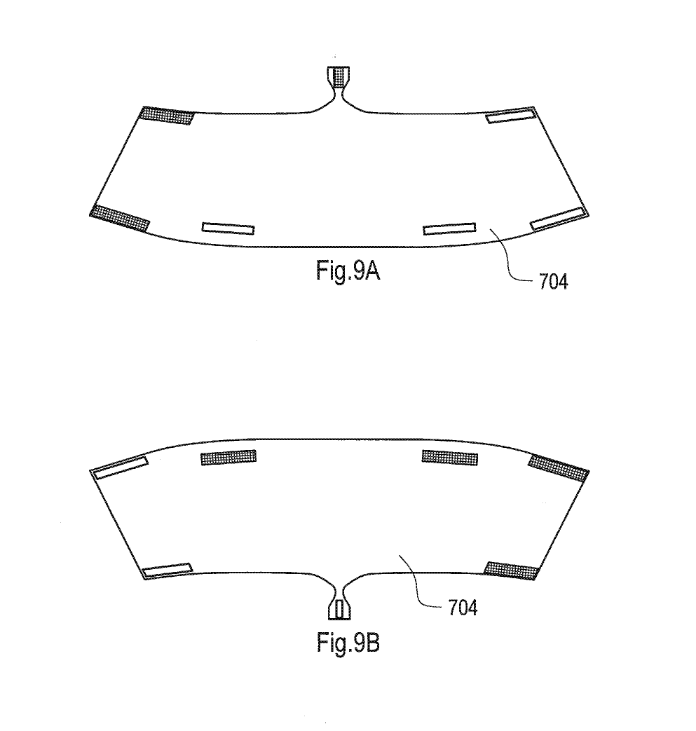

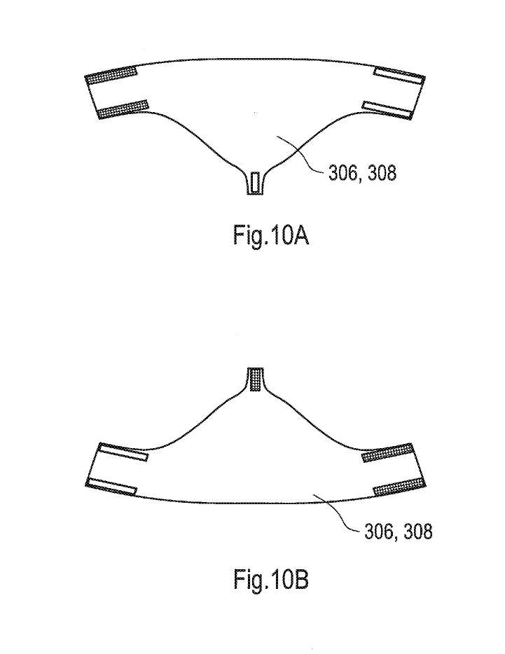

A further embodiment of the invention is shown in FIGS. 7A to 10B. In this embodiment, in a comparable manner to that described in FIGS. 1A-3, a full bikini pattern design is applied using the stencil arrangement 20e. This arrangement includes a shoulder mask 702, and a more extensive torso mask 704. A tab 706 connects the shoulder and the torso mask using a removable attachment device or affixation means, such as tape, a snap, or hook and loop devices such as Velcro strips. The thigh masks 306, 308 are connected using an affixation means such as a tab 708 as well.

In another aspect, the invention includes a placement apparatus and method of producing body applications, in mass, pattern designs on subject individuals. The apparatus has a frame and, typically, a footing support that maintains the frame a distance above the ground. The frame can also be attached to a wall, in which case, no footing support for the stencil is necessary. The stencil is attached to parallel, upwardly extending bars which are preferably tilted in one direction to enable the subject individual to lean into the stencil. The stencil optionally is slidable along the bars to position the stencil so as to properly position the pattern design when painted on the subject individual. Hooks or pins in the frame which match with holes in the material of the stencil interlock to hold the stencil in place once the desired positioning is attained.

In a variant, the bars are hinged and are moved to press the stencil against the subject individual. Two such moving frames may apply the stencil in a clam like fashion, to enable applications of pattern designs on both sides of the body of the subject individual simultaneously or consecutively.

In another variant of the invention, the apparatus is a pressure chamber which seals the pattern design against the individual via a vacuum or pressure chamber.

In another variant, the invention provides a means for preparing spray-on, or painted on clothing and a convenient tool having at least a roller and a cutting edge, for cutting a clean edge.

In another variant, the invention provides a means for quickly preparing skin prosthesis which is inexpensive and aesthetically pleasing.

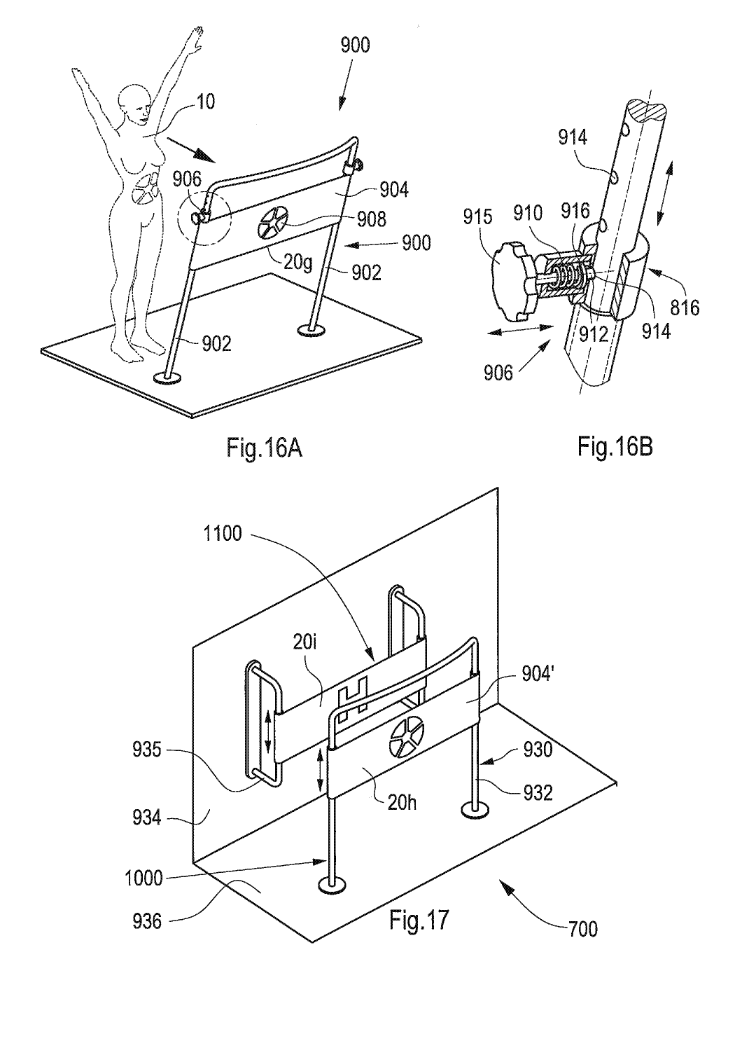

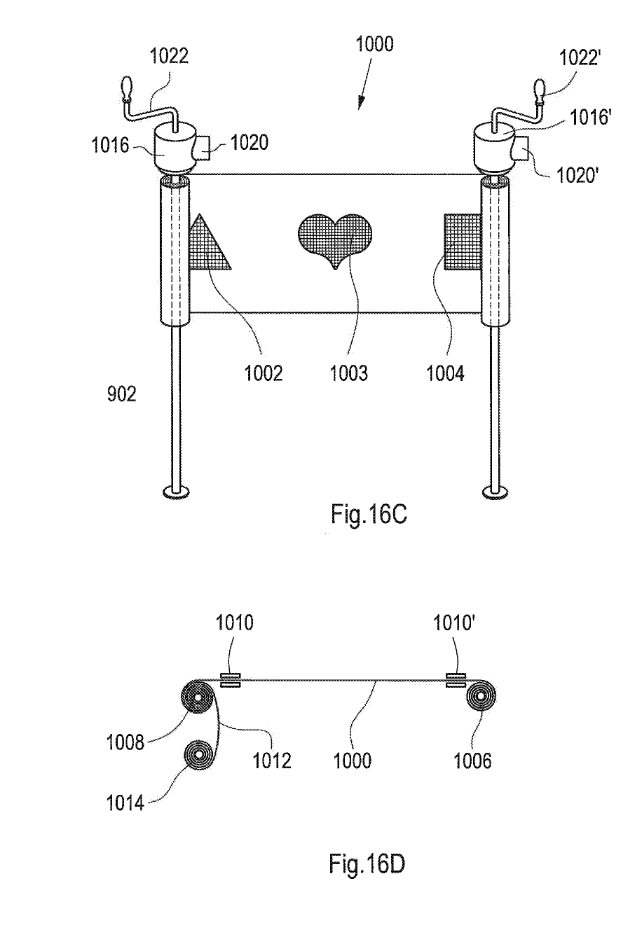

Referring now to FIG. 11, in another embodiment, the invention 800 is a system for automatically orienting a stencil 802, 806, or stencil arrangement 20f on the front and back of an individual 10. One stencil 802 is attached on a first jaw-like structure 804 (sometimes referred to as a “jaw”) of the system and optionally another stencil 806 (or sling-like body support device if no stencil is used) is attached to a second such structure 804. Each stencil 802, 806 is held extended out from the corresponding jaw structure on, for example, three, respectively two extending bars 810, and are positioned with respect to each other to overlap with the bars of the opposite jaw, so that the stencils can be more effectively pressed against the torso of an individual that stands in between the jaws with arms raised, with the stencils 802, 806 oriented according to the height of the individual by sliding a right or left stencil carriage 812 along the right or left, upwardly extending bars 814 of each jaw. A spring detent 816 (shown in detail in FIG. 16B) may be used to unlock and lock the respective stencil carriage 812. Weights 820 on a separate structure 822 are attached to a cable 824 which extends around a pulley 826 to a fixation point 830 on a jaw to draw the jaw closed around the individual. Optionally, where the individuals themselves do not apply the body paint via the tools mentioned in this application (brush, roller, airbrush, sponge etc.), applications robots 840 known in the art are used for automatically treating the individuals. Note that only one applications robot 840 is required if paint is to be applied to only one side of the individual 10 or if the robot is centrally mounted such as above the individual, or if the robot may reposition itself by for example, sliding along a track, in this case, a circular track.

Optionally, preferably after release of the jaw, a drying step dries the applied body paint. An air tube for directing air to the body paint may be permanently mounted in the system 800 or the robot 840 may direct such air tube to the applied paint, at an appropriate distance away for optimal drying. Alternatively or in combination, UV light may also be applied by a permanent fixture or directed by the robot to the wet paint.

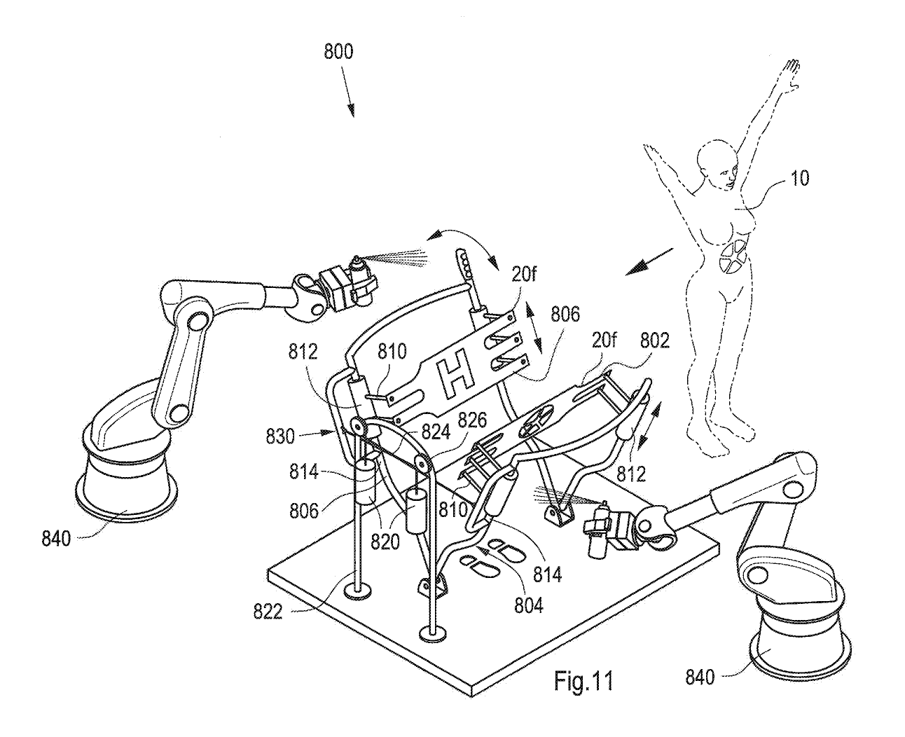

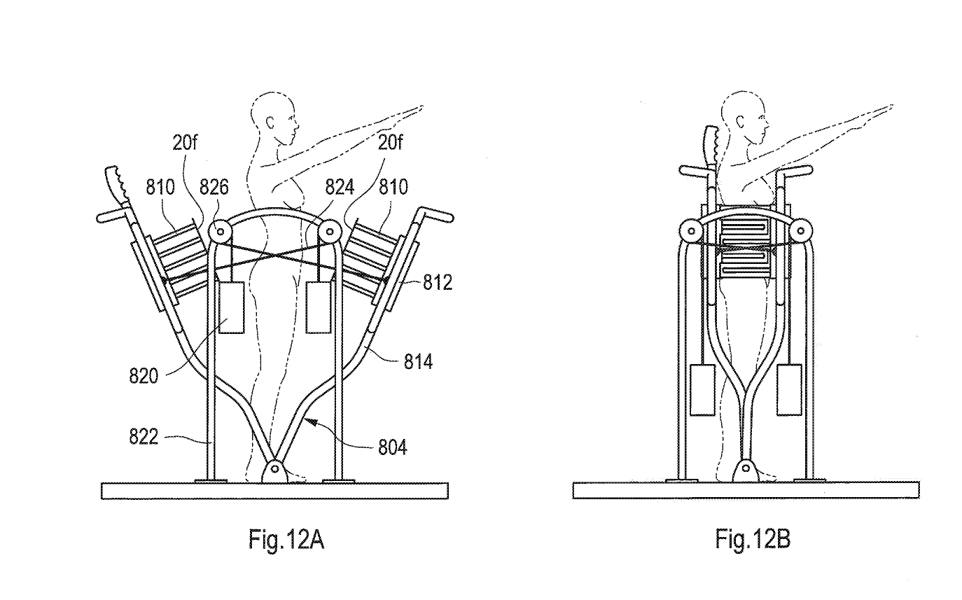

Referring to FIG. 12A, the embodiment of FIG. 11 has jaws 804, 805 shown in an open position.

Referring to FIG. 12B, the embodiment of FIG. 11 has jaws 804, 805 shown in a closed position.

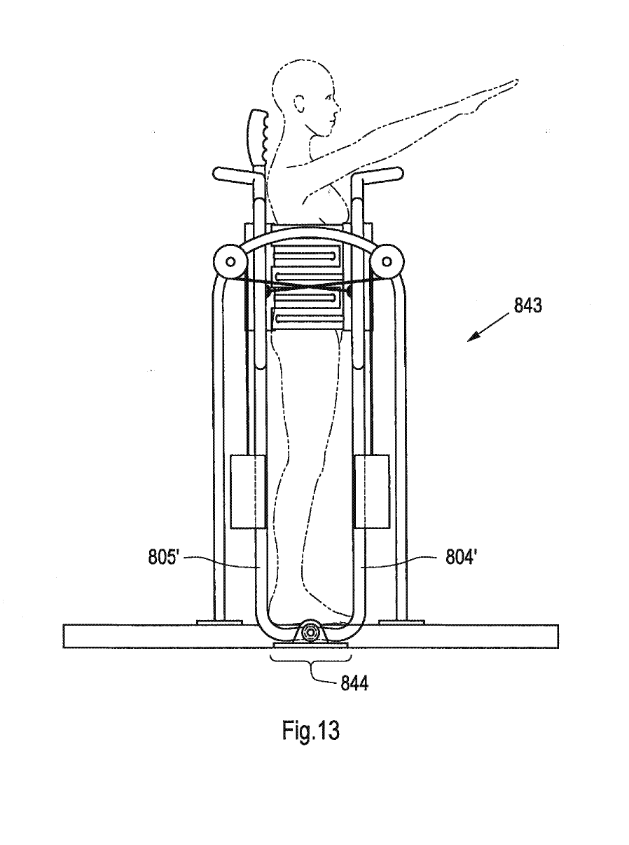

Referring to FIG. 13, an alternate system 843 has jaws 804′, 805′ that is made so as to form a U-shape in the closed position, thereby providing more clearance for an individual to enter into the jaw arrangement 844. Such an arrangement appears less threatening and is more comfortable to enter.

Referring to FIG. 14A, only the stencils and the individual is shown for clarity. In this view, it is more clear, in combination with FIG. 14B, how the ends of the stencils overlap and cross each other.

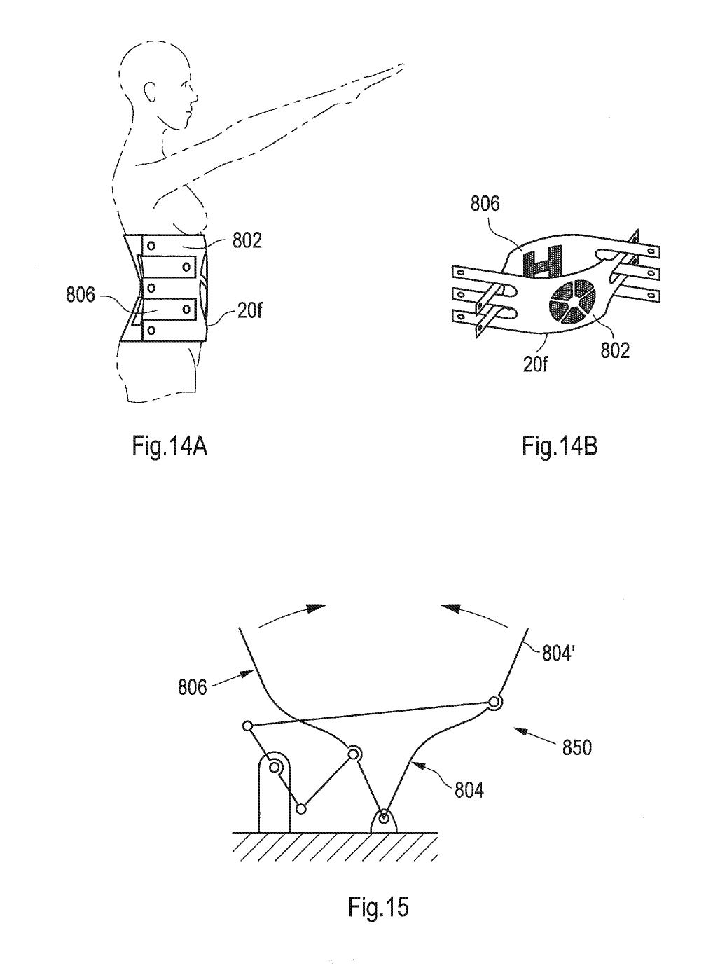

Referring now to FIG. 15, a linkage arrangement 850 draws one jaw 805 up when the other jaw 804 is drawn closed by pulling on the upper portion 804′.

Referring now to FIG. 16A, in a simpler embodiment 900, a frame 902 supports a single stencil 904 or stencil arrangement 20g and includes the height adjustment mechanism 906, to adjust the height to position the stencil over the desired location of the individual 10. Here, the individual simply leans into it, and the paint is applied to the non-masked area 908. The individual may apply the paint himself, or a robot or another person may apply the paint. The individual then removes himself from the stencil, leaving the desired pattern design.

Referring to FIG. 16B, the detent mechanism 906 is shown in more detail. A spring 910 retains the plunger 912 in a positioning hole 914. By pulling on the knob 915, a flange 916 compresses the spring 910 and pulls the plunger 912 out of the hole, thereby permitting repositioning in another hole on the frame 902.

Referring to FIGS. 16C and 16D, in a modification, the pattern design may be chosen by adding a film-like reel 1000 of different pattern designs 1002, 1003, 1004, also made of a stencil material, and moving end reels 1006, 1008 to reel as in an old movie projector, selecting the pattern design 1002, 1003, 1004 by turning an end reel 1006, 1008 on one end of a first support bar 902 which then draws the reel of pattern designs from a roll on the other end to a point where a selected pattern design 1003 is presented. Optionally clamp pairs 1010, 1010′ hold the reel 1000 on both sides of the subject individual so that he or she may apply their body pressure against the stencil without the reel 1000 unwinding on its ends. In a simple embodiment, given that the pattern design edges become contaminated with paint, it may be best to have a roll of pattern designs that offers repeating pattern designs and turns in one direction to avoid wet paint from contacting rolled up surfaces, which would be the case if the reel 1008, for example, were reversed. After completion of a roll, the reel 1000 is washed in a washing step.

In a more complex solution, again, due to the fact that when rolled against itself, wet paint from a prior application may dry and cause the rolled pattern designs on the reel 1000 to stick against each other, an inter-layer 1012 is added, such layer being typically of material to which the paint does not stick and so may be PTFE (often referred to as “Teflon”) coated or oiled, or may be an absorbent material that absorbs the paint, such absorbent material having an oil or non-stick additive applied thereto, to ensure non-sticking of adjacently applied layers. A relatively rigid inter-layer of high gloss, dense, non-absorbent material could also be used. A third reel 1014 also ideally rolls up the non-stick inter-layer 1012 and is activated by a return spring (not shown) so as to automatically recoil into a rolled up position. In such a case, to ensure a true application of the pattern design 1002, 1003, 1004, most pattern design openings in the stencil should be netted (have a net material applied over the opening), or have edges reinforced, or both, as herein already described. In addition, a motor 1016, 1016′ such as a stepper motor may be connected to one or both posts, and a control 1020, 1020′ provided at the disposition of the individual to be painted, that allows the individual to select the pattern design 1002, 1003, 1004 he or she wishes to apply. Which two motors 1016, 1016′, and a tension sensor measuring the tension in the stencil or the return springs (not shown), the system can adjust or control the tension in the stencil material so as to improve the sealing of the edges of the pattern design opening, and so create a crisper painted stencil pattern. A spring return mechanism (as in a roll-up projector screen or a tape measure with a retraction spring) combined with a stepper motor or a manual roll up handle 1022, 1022′ on one or the other reel 1006, 1008 may also be added to bring the desired pattern design into position. Of course, this is preferably combined with the decent mechanism 906 that allows height adjustment for ease of positioning the pattern design on the subject individual.

Note that a combination of using the inter-layer and washing separately, after use of an entire reel 1000 is also contemplated.

Referring now to FIG. 17, an even simpler embodiment 930 as compared to that of FIG. 16A, has a frame 932 that is erect and may otherwise be identical to the embodiment 900, supporting a stencil 904′ or stencil arrangement 20h. The individual 10 simply walks against the stencil after the height has been positioned to match the individual. A version in which the stencil 20i is mounted on an extending frame 935 mounted to the wall 934 and not to the floor 936, is also shown and may be used in a similar manner, including the stencil being mounted on the wall slightly reclined as in the embodiment 900, allowing the individual 10 to lean into it as well.

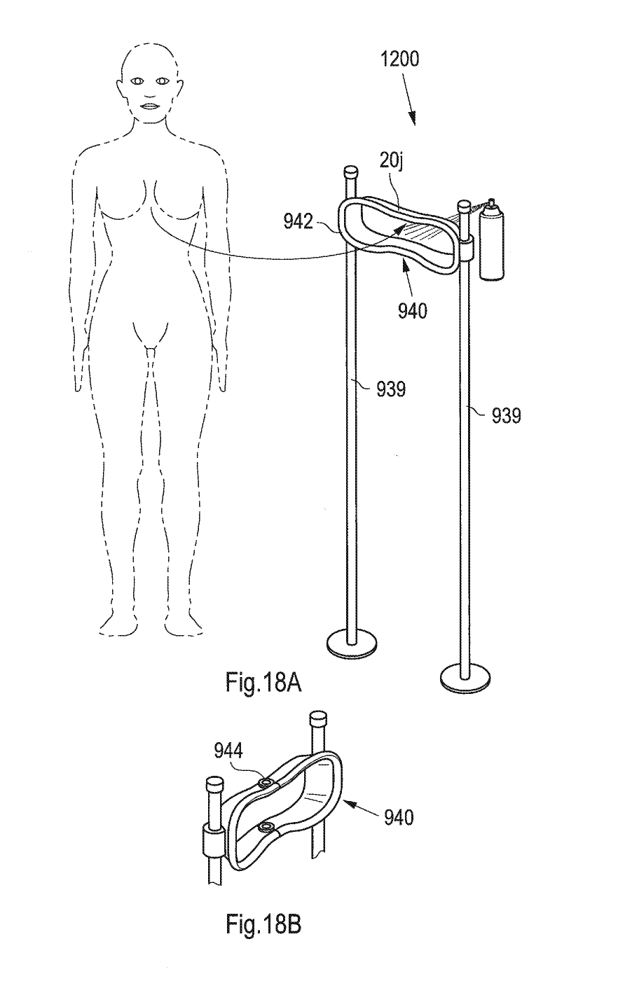

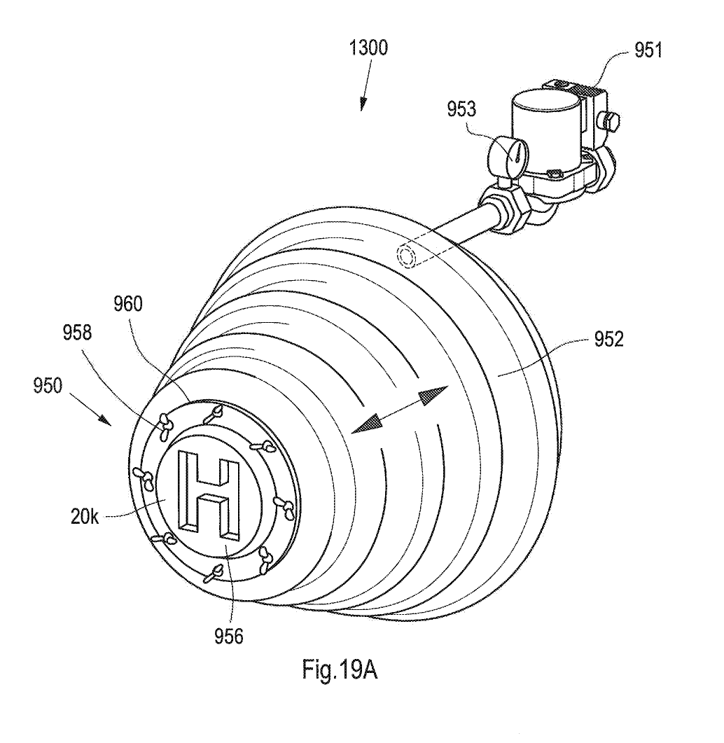

It should be noted that the stencils used in the invention of FIGS. 11-17 are preferably flexible to conform to an individual's body, the contours of which vary from person to person. However, the stencils may also be rigid given that the human body is flexible and can conform to the stencil to a certain degree. Rigid stencils are particularly useful when a part of the body must protrude out of the stencil, therefore not permitting netting to maintain the form of the pattern design to be painted. Referring now to FIGS. 18A and 18B, supported on bars 939 for example, the stencil 940 or stencil arrangement 20j may be rigid in its entirety and the edge portions 942 which delineate the pattern design are made may be semi rigid, such as a scuba mask having only sealing edge which is flexible. The opposite may also be the case. The edge portion 942 of the stencil 940 extending from the edge of the pattern design contour inwardly away from the edge may be rigid. Rigidity can be gained by increasing the thickness of the material adjacent the edge, changing the type of materials from a fabric to a solid plastic. Depending on the thickness of this semi-rigid edge region, it need only extend 5 mm to 10 mm from the edge. However, for simplicity of production, the edge portion may be an insert in the fabric of the stencil, which insert may have a square or round periphery for standardization and fit with the stencil. Consequently, the distance from the edge of the semi-rigid portion may vary. In another variation, the stencil may be made of two or more portions that are hinged together with flexible hinges 944.

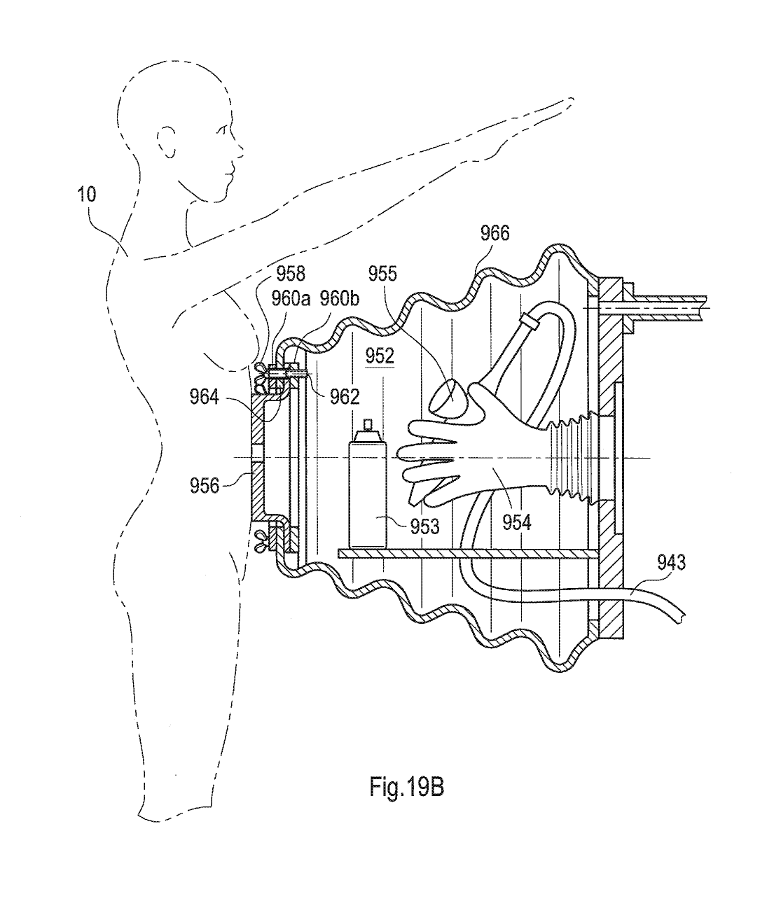

Referring now to FIGS. 19A-19B, another variant 950 of the apparatus for mass production of body painted pattern designs uses a pressure chamber 952 in which a pressure differential from ambient is created with, for example, a pump 951. The body paint or fixing spray 953 is either stored in the pressure chamber 942 or directed therein via a supply line 943. A pressure-sealed glove 954 is provided to allow a human operator to apply the paint without breaking the pressure differential, be it a vacuum or positive pressure. A pressure sensor 953 senses the pressure in the pressure chamber 952 and only when the pressure is below or above ambient by a certain amount, does it permit the air brush 955 to paint. In this manner, applications are only permitted when the pattern design is sealingly applied to the body of the subject individual. Of course, an automated applications system (not shown) located functionally inside the pressure chamber 952 can also be used. The stencil 956 or stencil arrangement 20k is an insert that is sealingly held in place by clamps 958 and clamping rings 960a, 960b through which the clamps (a screw 962 for example) extends so as to sealingly clamp on an edge portion 964 of the accordion portion 966 of the pressure chamber 952. This variant 950 takes further advantage of the flexibility of human skin, to provide a significant measure of compliance to seal against the pattern design. Note that when a substantially sealed pressure chamber is used, overspray can be filtered out. In addition, a UV lamp can be included inside the pressure chamber, curing the paint before the seal on the body of the subject individual is broken. Of course, a single large spray pattern spray may be applied which applies paint on the skin without having to move the spray nozzle relative to the area to be painted. Alternatively, a rotating motion may automatically be imparted, ensuring more even coverage while still

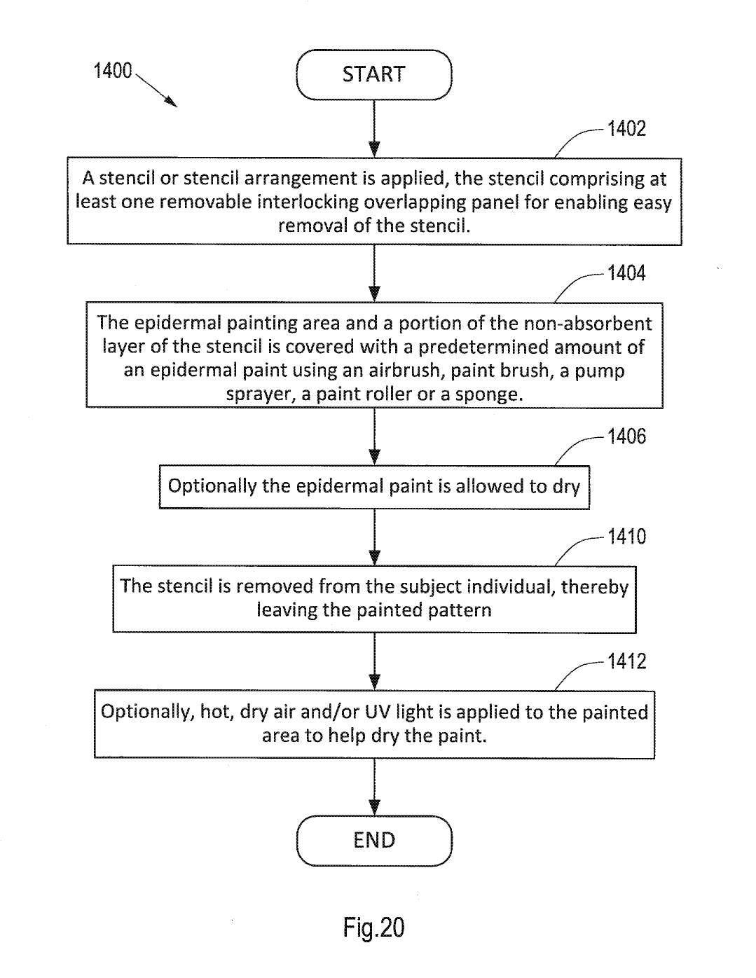

Referring now to FIG. 20, the method 1400 of body applications in mass as applied to a subject individual 10. In a first step 1402, a stencil or stencil arrangement 20a-20k is applied to the individual 10 having a pattern design delimited thereby around an appendage of a subject individual (in this figure the upper thighs and waist), masking thereby a predetermined area of the epidermis. In arrangements 20a-20e, the stencil comprising at least one removable interlocking overlapping panel for enabling easy removal of the stencil, the stencil itself providing an opaque essentially non-absorbent layer which protects the underlying epidermal area from an applied body paint, defining further a masked epidermal applications area corresponding to a desired pattern design. In a second step 1404, the epidermal applications area and a portion of the non-absorbent layer of the stencil is covered with a predetermined amount of an epidermal paint to cause the epidermal paint to contact the epidermis only via the pattern design masked by the stencil. In a third step 1406, optionally the epidermal paint is allowed to dry, a portion of the epidermal paint covering the portion of the epidermis that is coextensive with the pattern design masked by the stencil to form a decorative applications in the epidermis in the form of the pattern design. In a fourth step 1410, the stencil is removed from the subject individual, thereby leaving the painted pattern design. Optionally, in a fifth step, hot, dry air and/or UV light is applied to the painted are to help dry the paint.

In the method above, the paint is optionally applied in a manner that does not generate overspray, such as with a brush and/or paint roller or sponge. The individual may themselves apply paint using a brush in nooks and crannies (areas hard to reach with a roller), and then may themselves, or with the help of a partner, apply the remainder using an air brush, a sponge, pump sprayer, or paint roller wherein the paint is applied to the paint roller via a paint reservoir having a rolling application surface as is known in the prior art.

After application of the basic pattern, the user may use standard flat stencils to embellish the basic design. If the basic design applied is that of a one or two piece bathing suit, it would be appropriate to apply star/moon forms or other forms to the already applied paint, preferably once the applied paint has dried. The result is a body painted bathing suit with embellishments of artistic merit that takes typically less than thirty minutes to apply, compared to 2 to 15 hours using methods of the prior art.

In one embodiment, the invention provides a method of assigning body paint or T-shirts to individuals attending a concert or sporting event, optionally motivated by discounted tickets to such events, by which a sponsor wishing to communicate a logo or message made up of “pixels” made up of individuals, can do so by a software program which lays out the message in a stadium or concert hall of seats, forms a message, and assigns colors to individuals seating in reserved seats whose location correspond to the location of colored pixels required to form that logo or message. The assignments correspond to tickets for these reserved seats, such tickets prescribing a dominant color, which can be that of a sports team, a sponsor's logo, etc. The apparatus of the invention applies the method and apparatus of the invention to paint the individuals in colors according to their reserved seating, thereby creating a sponsor message or logo or other symbol.

In another embodiment, the invention applies temporary tattoos via an inkjet, such as a 2015 Epson DX5 Inkjet printer (with the built-in UV curing lights deactivated) having cartridges filled with UV curable ink using a novel application method. A suitable ink is the UV curable ink from Inkmed Inkjet Technology Co., Ltd, Inkmed UV Curable Ink is featured as wide color sphere, vivid color, fine curing effect and strong adhesion. In order to apply this method, color cartridges of a standard ink jet (not laser jet) printer are filled with a suitable UV curable ink. The UV inks remain liquid until exposed to curing UV light, therefore avoiding problems of printhead blockage & machine down time. The UV inks are the best ecological choice of inks with essentially no harmful fumes or VOC's, providing fast print rates & fast curing times. In a first step, a non-ink-absorbing substrate is loaded in the printer. In a second step, the desired tattoo image is printed. In a third step, the transparency sheet is removed. In a fourth step, the sheet is applied to the skin so as to transfer the ink thereto. In a fifth step, the sheet is removed, leaving the pattern design on the skin. In the sixth step, UV lights is directed to the ink. IN a seventh step, optionally, fixing spray is applied. In the first step, a non-ink-absorbing substrate such as a high gloss transparency film (such as used for view graphs and old overhead projectors) is loaded in the ink jet printer so configured to lay UV curable ink. In the second step, a print order is given to the printer to print a desired tattoo pattern design and the ink jet prints on the transparency film, which is ejected from the printer. In the third step, the printed transparency sheet is removed from the printer exit tray. In the fourth step, the printed side of the transparency is placed against a surface of the skin on which the temporary tattoo is desired. Relative movement of the skin with respect to the transparency film should be avoided to minimize smearing of the ink. The non-printed side can be pressed against, even rubbed so as to ensure a maximum application of the wet ink to the skin. In the fifth step, the transparency film is removed leaving the pattern design on the skin. In the sixth step, a UV light typically used for curing nail polish gel, is directed to the applied ink for about 3 minutes. In the final step, fixing spray or hairspray is applied to the tattooed area to seal the tattoo and increase its longevity.

In another embodiment, the method of the invention involves several steps. In a first step, the UV light projector (any light projector having a UV light emitting bulb) is oriented and fixed with respect to the application area. In a second step, a UV curable ink is applied apply over the area on which the pattern design is to be applied. In a third step, the UV projector projects UV light in the form of the pattern design on the skin where the UV ink has been applied. In a fourth step, a curing time is allowed to pass. In a fifth step, excess ink is wiped away. In a sixth step, a fixing or hair spray is applied. In more detail, in the first step, the area of the skin to which the pattern design is to be applied is fixed with respect to a UV light projector capable of projecting the pattern design on the area of the skin to which the pattern design is to be applied. In the second step, a UV curable ink is applied (using a brush or roller for example) to the area of the skin on which the subject individual wishes to apply a temporary tattoo. In the third step, the oriented UV projector is turned on so as to project UV light in the form of the pattern design on the area on which the pattern design is to be applied. In the fourth step, a curing period of time is allowed to pass, typically 3 minutes. In the fifth step, the excess and uncured wet ink is removed from the application area and the area is allowed to dry. In the sixth, a fixing spray or hair spray is applied to increase the durability of the applied temporary tattoo.

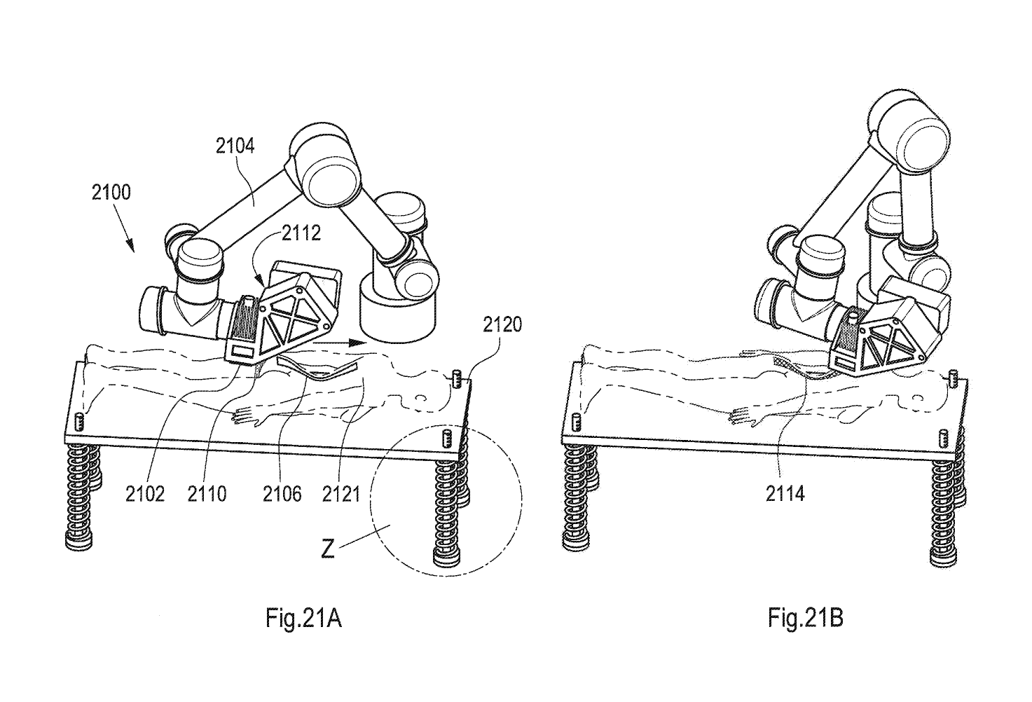

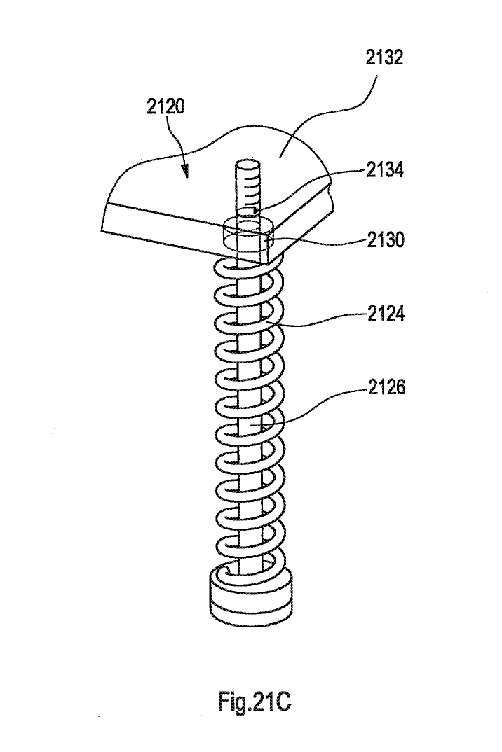

Referring now to FIGS. 21A, 21B and 21C, in another embodiment 2100, the invention uses a specialized treatment head 2102 such as a printer or ink injection device with a moveable arm 2104 adapted to treat in close proximity, and in one embodiment, non-touching proximity to any smooth 3D skin surface 2106. In the particular variant in which a printer head 2102 is used, the printer, scanner 2110 and robot arm arrangement 2104 (information available at http://www.3 ders.org/articles/20131010-innovative-3d-printer-prints-on-complex-and-bent-surfaces.html), a collaboration with Dutch company Oc\tilde{e} Technologies and researchers at the Delft University of Technology Robotics Institute in the Netherlands, works by means of the robot arm 2104 with various degrees of freedom combined with a high-performance printer head 2112 from Oc\tilde{e} and a laser scanner, combined with an optional conversion software for converting a 2D treatment plan to the 3D surface of the skin to be treated. Note where the treatment plan is developed directly on the scanned 3D surface, no conversion step is required. Another suitable type of device, adaptable to the needs of the present invention is the LAC Art Robot NV3.1 or later editions, which is an airbrush robot with a scanning and printing or spray head as in the OC\tilde{e} device described above. This LAC Art Robot is a digital airbrush painting system for direct painting or printing on a 3D surface. The LAC robot has a printing area of 2M×3.1 meters. The spray head has four spray nozzles which spray the basic colors cyan, magenta, yellow, and black, enabling the spraying with a color depth of typically up to 16.7 Million colors.

Traditional specialized treatment heads such as printer heads typically are only able to move along straight lines, but a robot arm such as the one from Delft is able to print in all directions in three dimensional space, which means that the arm can move the specialized treatment head along complex, curved surfaces such as a human morphology. The Delft device must be adapted to include a printer head 2102 using known ink jet printing technology thereby being able to lay down wet ink in any color and in any 3D form which does not deviate from a 2D surface by more than a practicable amount given the size of the components. The logo or tattoo pattern design to be printed is typically of course a 2D image projected on the 3D surface 2106. The laser scanning accomplished by the laser scanner 2110 located ahead of the printer head 2102 in the specialized treatment head 2112 provides the elevation information (off the 2D plane of the image or treatment plan) necessary to the conversion software for the printing head to adapt the 2D image to the 3D surface so that printing and/or treatment is sharp despite the rise and fall of the surface 2106.

Referring in particular to FIG. 21C, as a safety measure, the table 2120 on which the individual 2121 is fixed for treatment (fixing optionally being comfortably secured to a table, by there being a bean-bag type mattress, for example, interposed between the patient an the table, a cushioned aperture in the table optionally being provided for the face to extend during treatment) is supported so as to yield or give in should the treatment head 2112 deviate from the intended programmed path, in order to reduce the risk of injury to the individual. Such can be accomplished using elongated support springs 2124 which are place around the sport leg 2126 which extend from foot pads 2128 through bushings 2130 and the table surface 2132 do as to slide along the bushing. The patient has a given weight, and so the table 2120 will take a specific equilibrium position 2134 when the individual 2121 lays on the table. The equilibrium position 2134 is registered and communicated to the treatment device 2100, along with information as to the location area 2106 is where the treatment is to take place. If the position of the individual 2121 deviates from the registered equilibrium position 2134 by a set amount, a cut-off signal is sent to the robot arm 2104, cutting off all power and stopping the treatment. Location and state information may be saved to permit resumption of the treatment once any problems are corrected. This typically involves a caching step which saves the information related to the setup and position at the time of cut off to permit a resume if desired. However, given that the ink is not yet cured, it is probably best to clean off the ink and restart the procedure. This safety device is effective particularly where the treatment does not involve the transmission of force between the robotic gimbal head and the patient, such as when an ink jet head is used.

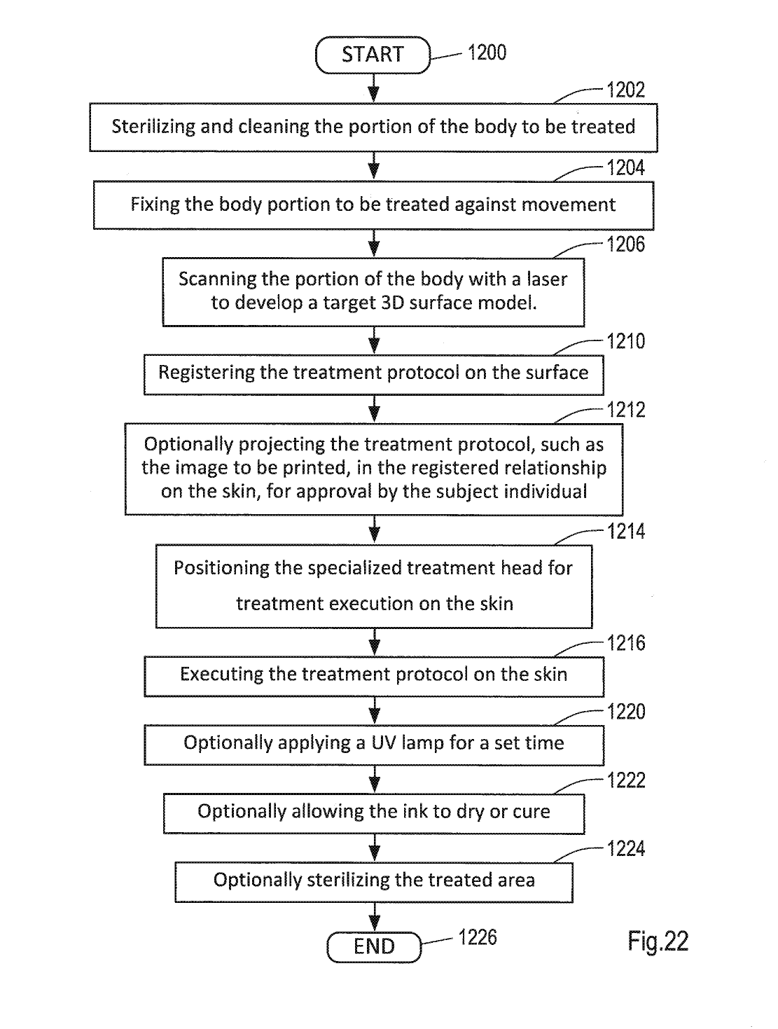

Referring now to FIG. 22, the method of the invention used in the apparatus of FIG. 21A to 21C, includes several steps. In a first step 1202, the portion of the body to be treated is sterilized and cleaned. In a second step 1204, the portion of the body to be treated is fixed against movement (which may simply be the placement of the subject to be treated on a table and ask that they not move). In a third step 1206, the portion of the body is scanned with a laser to develop a target 3D surface model. In a fourth step 1210 (which using the Delft device may occur at the same time as the third step), using data from the laser scanner, the treatment plan (e.g., image to be printed or bandages or clothing to be sprayed) is registered on the surface. In a fifth optional step 1212, using a separate projector device which retrieves the scanned, registered information from the control software system, the treatment plan (again, for example, the image to be printed) is projected in the registered relationship on the skin, for approval by the subject individual 2121. In a sixth step 1214, a specialized treatment head such as a 3D printer head or, in another embodiment (in which treatment involves contact), a specialized treatment head is positioned for treatment of the skin. In one embodiment, this is a tattoo ink injecting head. In another embodiment, it is an ink jet printing head. In another embodiment, it is a spray-on clothing or bandage head. The specialized treatment head can always be positioned perpendicular to and at the correct distance from the surface. In a seventh step 1216, skin is treated or application is applied, such as the image is printed on the skin. In an eighth optional step 1220 when UV ink is used, a UV lamp is applied to cure the ink. Alternatively, in a curing step 1222, a henna ink or other body paint can be applied by the printer, for which no UV curing is required. Where tattoo ink is applied, a sterilizing step 1224 is added. In a ninth step, the applied material is allowed to dry or cure.

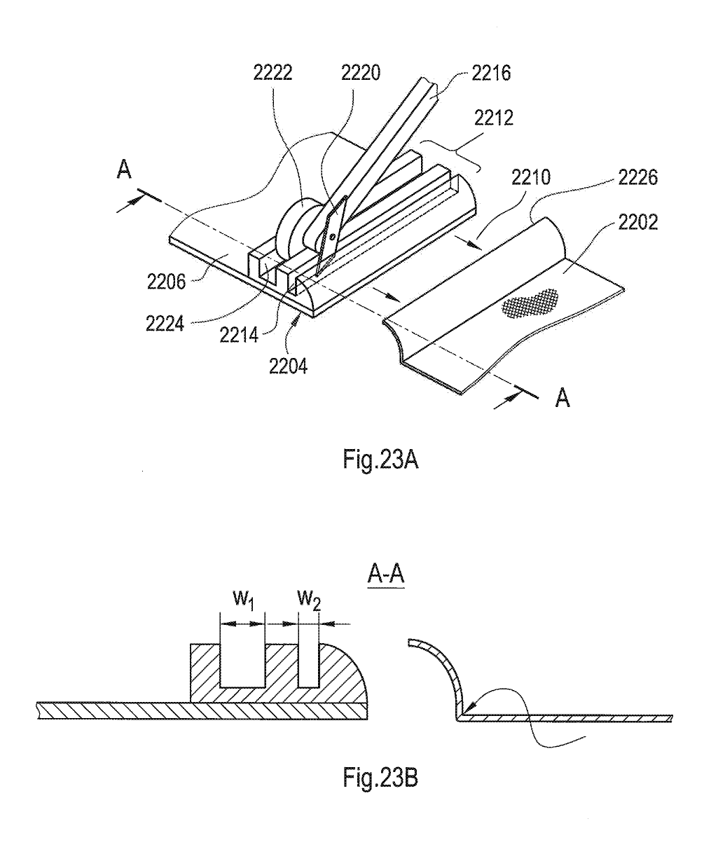

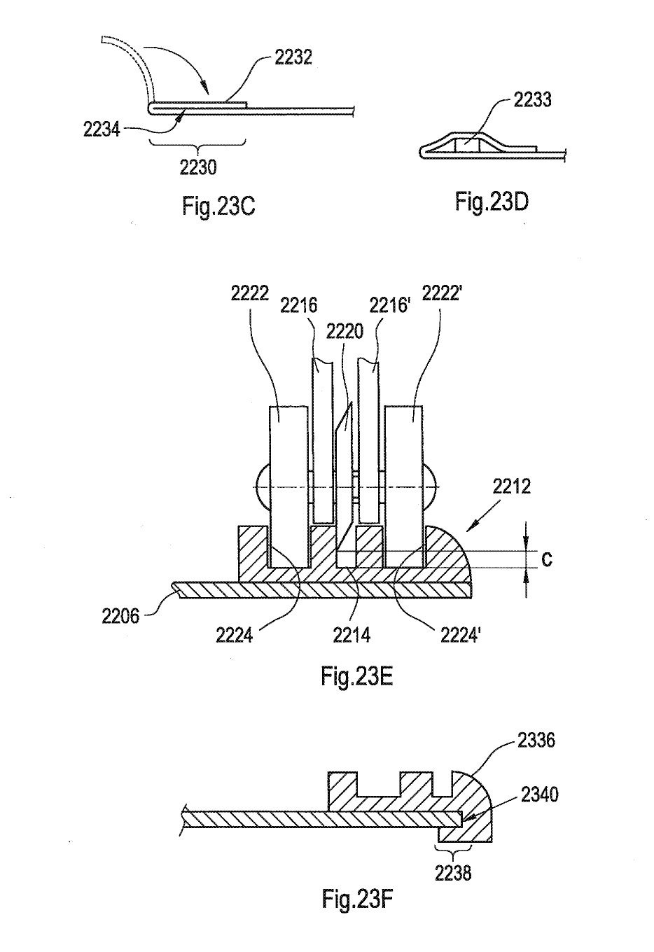

Referring to FIGS. 23A-23F, in another variant, instead of ink, spray on fabric (suitable for clothing or for bandage material) 2202 can be used. In such an embodiment, the edges 2204 of each mask 2206 adjacent to the edges 2210 of the pattern to be formed optionally include a channel trim section 2212 (typically extruded of flexible plastic or rubber and glued to the edge 2204) which has at least one channel portion 2214 is used as a guide for a sharp instrument 2216 having a sharp blade 2220. Shown in FIG. 23A is a special purpose cutting instrument 2216 having such a blade 2220, which extends partially into a narrow channel 2214 preferably closest to the edge 2210 of the pattern to be formed, as well as a roller or wheel 2222 sized to roll in a preferably wider channel 2224 adjacent the cutting channel 2214. Alternatively, in FIG. 23E, a version of this instrument 2216′ may have two rollers 2222 and the blade 2220 positioned therebetween to better protect against cutting of the skin of the subject individual or painter and that of course, there would be corresponding channels 2224 and a cutting channel 2214 in the trim section is shown with two channels. Such a specialized instrument 2216 provides a smooth and attractive cut and minimizes the risk that when cutting the edge, the subject individual will be cut or injured. Note that an “exacto knife” could also be used but with greater difficulty and increased risk of injury. As before, the masks are applied, delineating the form of the pattern. The spray fabric 2202 is applied to the pattern design area. The spray fabric 2202 is allowed to dry. Then either the masks are removed and/or the edges 2203 which the masks marked in the fabric are used to cut the fabric with a scissor, or a sharp instrument is entered into the guide or channel 2214 to cut the fabric to create a suitable edge 2226 to the sprayed-on clothing. The excess is removed, the masks are removed leaving the final product, namely the sprayed on article(s) of clothing, in place on the wearer. A seam 2230 may be created by folding down the excess edge portion 2232 and gluing (by applying glue with a brush, roller or spray can for example) at the interface 2234 to create an attractive, nicely tailored spray-on garment. Once the glue is sufficiently dry and assuming the spray-on material is not applied too thickly (as it would typically be for bandages), the sprayed-on garment, when removed and turned inside-out, creates a perfectly fit, finished and nicely trimmed product.

In FIG. 23D, an elastic band 2233 such as an elastic strip or rubber band is interleafed in the tailored edge or seam to improve re-wearability.

In FIG. 23F, an alternate profile 2336 has a portion 2338 which curves over the edge 2340 of the stencil to help in aligning the same with the edge of the stencil, for ease of manufacturing (due to its ability to be more easily registered with the edge of the stencil).

An example of a spray on system uses “FABRICAN”™ developed by Dr. Torres and Paul Luckham, professor of particle technology at Imperial College London. A demonstration is available online at dailymail.co.uk/femail/article-1312399/The-shirt-spray-For-clothes-fit-like-second-skin-try-instant-fabric-can.html. “FABRICAN” consists of cotton fibers, polymers and solvents which enable air-brush spraying. Of course, spray-on “LATEX”™, “SILLY STRING”, or similar materials may be substituted for “FABRICAN” to spray on clothing that can be removed by the subject individual and re-donned.

Note as well that the spray on fabric can also be painted on using a paint brush or roller. In addition, spanner inserts 315 can be used to span body crevices to smooth out adjacent surfaces, and avoid that the sprayed on clothing have sharp inflections that, due to the lack of ready accessibility, may have received only a thin application of spray-on fabric and so be susceptible to tearing on separating.

Prior to trim, the spray-on fabric may be treated by painting using a body paint or a latex, for example, to add color to the clothing and to increase the elastic memory. Alternatively, a latex coating (sprayed on or painted on) may be applied first, followed by a spray-on fabric, which, when removed and turned inside-out, provides a comfortable latex garment which protects to a certain extent against latex allergies. Conventional stencils may be used to embellish the spray-on clothing just as with body painting using the invention.

Alternatively, the spray-on clothing method of the invention can also be used to spray-on. FABRICAN, or similar spray-on fabric, formulated to be sterile and of material suitable for bandaging a wound. In a variation, a color, such as a skin color liquid latex body paint may be applied over the layer of already applied spray-on bandage composition to, in a further method step, create temporary, and to a certain extent, waterproof skin for burn victims. Advantageously, the bandage area is delimited by the application of the stencils of the invention. Alternatively, where latex is applied, an aerating device which cuts holes in the latex, may be used to give the skin a means for breathing. This hole cutting device may be a simple snipping device which pulls up the material (for example, by gripping on the latex and then, through mechanical action, pulling the material away from the skin) prior to cutting to avoid damaging the underlying skin.

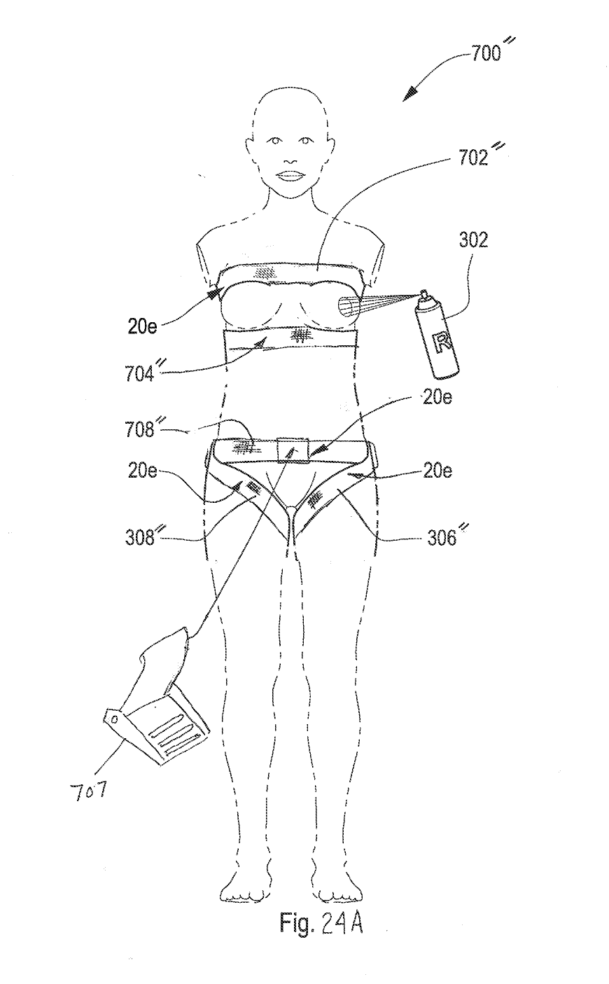

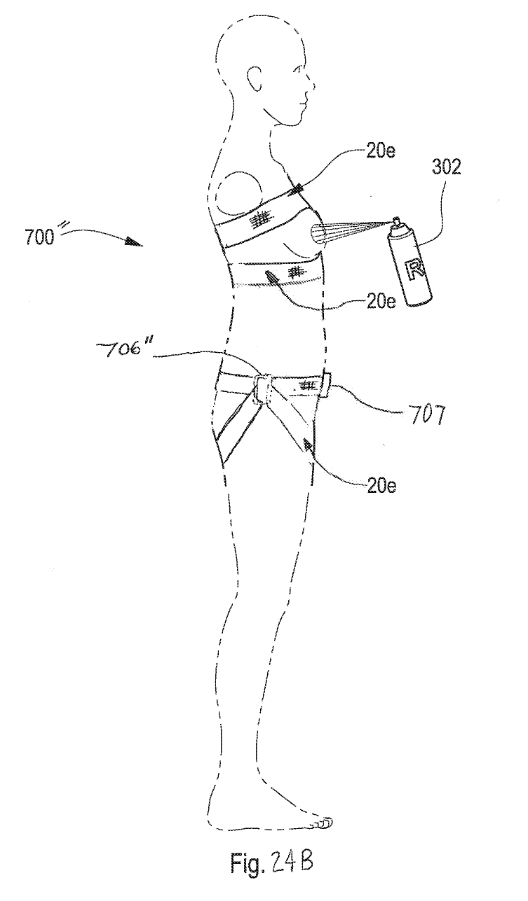

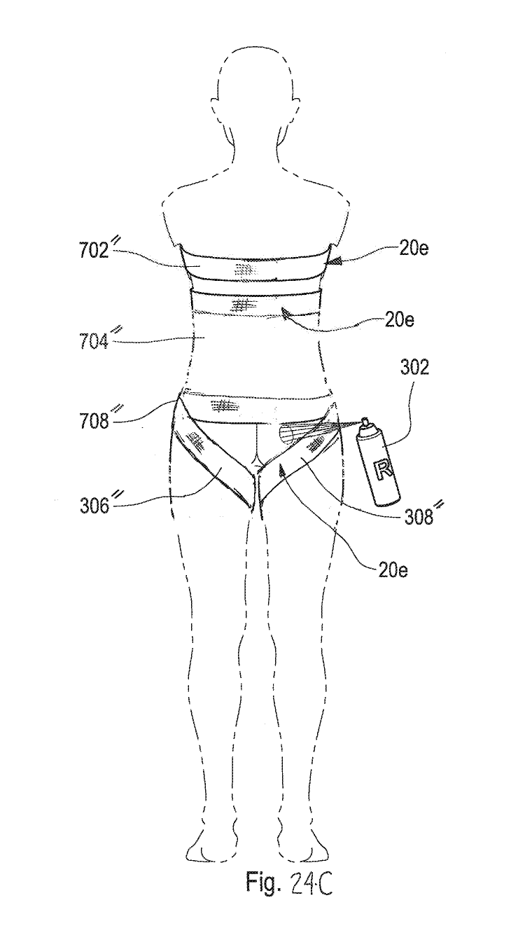

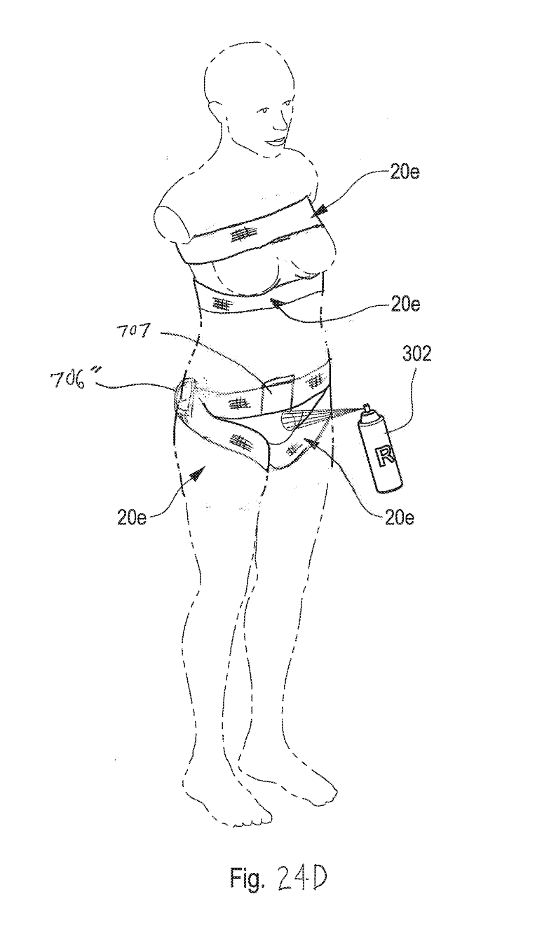

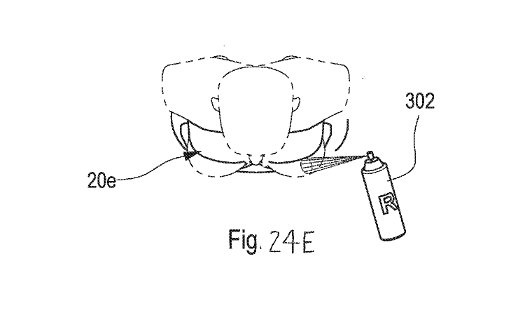

Referring now to FIGS. 24A-24E, an alternate embodiment of the invention uses elastic bands 702″, 704″, 708″, 308″, and 306″. The upper two bands 702″, 704″ form a sewn or welded closed, flexible loop that can be simply espanded and placed over the body. The lower bands 708″, 308″, and 306″ may optionally be one and the same band, wound around the body through D-Rings 706″ as best shown in FIG. 24B and connected together again using Velcro straps, or a buckle 707, for example, a cam buckle. The band width is preferably about 50 mm, in order to perform its function of masking properly. With this version, the lower mask can be adjusted to fit a larger variety of sizes, from petit to extra large. The upper two bands may have buckles (not shown) making them more adjustable to fit a large range of body sizes.

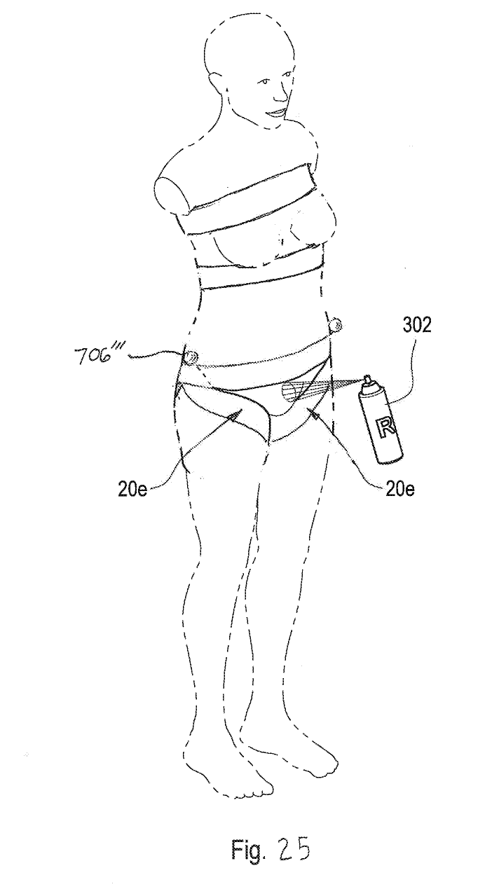

Referring now to FIG. 25, is very similar to the embodiment of FIG. 24A, but uses a bulky element 706′″ such as a ball, that is attached to a thigh encircling elastic band, and so may be tucked under the waste strap 708″. In this manner, no buckles are needed and the mask consists essentially of three simple closed elastic loops and two smaller elastic loops having bulky elements attached. Of course, other fastening elements may be used like “VELCRO” tabs or buttons, clips, etc.

It should be apparent that the bands 704″ and 708″ could be done away with when painting a one piece suit. In such an alternate embodiment, the bands 308″ and 306″ may be pulled up using a suspender device that also attaches to the uppermost band 702″. In an advantage, the invention allows applying a stencil to a 3D object and to remove the same without disturbing the applied paint.

In another advantage, the invention allows sponsors to contract for their logo to be mass applied during sports events.

In another advantage, the invention allows the stenciling of clothing made of body paint.

In another advantage, the invention allows the application of logos or pattern designs which are at least partially opaque, thus creating a more permanent pattern design in contrast to adjacent skin which is tanned while the logo or pattern design is worn. This allows phrases like “I love South Beach” or a pattern such as the form of a heart, to be “tattooed” on the wearer as a memento of a vacation.

In another advantage, the invention allows the rapid sealing of a pattern design against a body via creating a pressure differential from ambient.

It should be appreciated that the particular implementations shown and herein described are representative of the invention and its best mode and are not intended to limit the scope of the present invention in any way.

Moreover, the system contemplates the use, sale and/or distribution of any goods, services or information having similar functionality described herein.

As will be appreciated by skilled artisans, the present invention may be embodied as a system, a device, or a method.

Moreover, the system contemplates the use, sale and/or distribution of any goods, services or information having similar functionality described herein.

The specification and figures should be considered in an illustrative manner, rather than a restrictive one and all modifications described herein are intended to be included within the scope of the invention claimed. Accordingly, the scope of the invention should be determined by the appended claims (as they currently exist or as later amended or added, and their legal equivalents) rather than by merely the examples described above. Steps recited in any method or process claims, unless otherwise expressly stated, may be executed in any order and are not limited to the specific order presented in any claim. Further, the elements and/or components recited in apparatus claims may be assembled or otherwise functionally configured in a variety of permutations to produce substantially the same result as the present invention. Consequently, the invention should not be interpreted as being limited to the specific configuration recited in the claims.

Benefits, other advantages and solutions mentioned herein are not to be construed as critical, required or essential features or components of any or all the claims.

As used herein, the terms “comprises”, “comprising”, or variations thereof, are intended to refer to a non-exclusive listing of elements, such that any apparatus, process, method, article, or composition of the invention that comprises a list of elements, that does not include only those elements recited, but may also include other elements described in the instant specification. Unless otherwise explicitly stated, the use of the term “consisting” or “consisting of” or “consisting essentially of” is not intended to limit the scope of the invention to the enumerated elements named thereafter, unless otherwise indicated. Other combinations and/or modifications of the above-described elements, materials or structures used in the practice of the present invention may be varied or adapted by the skilled artisan to other designs without departing from the general principles of the invention.

The patents and articles mentioned above are hereby incorporated by reference herein, unless otherwise noted, to the extent that the same are not inconsistent with this disclosure.

Other characteristics and modes of execution of the invention are described in the appended claims.

Further, the invention should be considered as comprising all possible combinations of every feature described in the instant specification, appended claims, and/or drawing figures which may be considered new, inventive and industrially applicable.

Copyright may be owned by the Applicant(s) or their assignee and, with respect to express Licensees to third parties of the rights defined in one or more claims herein, no implied license is granted herein to use the invention as defined in the remaining claims. Further, vis-à-vis the public or third parties, no express or implied license is granted to prepare derivative works based on this patent specification, inclusive of the appendix hereto and any computer program comprised therein.

Additional features and functionality of the invention are described in the claims appended hereto. Such claims are hereby incorporated in their entirety by reference thereto in this specification and should be considered as part of the application as filed. The abstract of the invention is also incorporated herein by reference in its entirety.

Multiple variations and modifications are possible in the embodiments of the invention described here. Although certain illustrative embodiments of the invention have been shown and described here, a wide range of changes, modifications, and substitutions is contemplated in the foregoing disclosure. While the above description contains many specific details, these should not be construed as limitations on the scope of the invention, but rather exemplify one or another preferred embodiment thereof. In some instances, some features of the present invention may be employed without a corresponding use of the other features. Accordingly, it is appropriate that the foregoing description be construed broadly and understood as being illustrative only, the spirit and scope of the invention being limited only by the claims which ultimately issue in this application.

What is claimed is:

1. A body stencil system comprising a body tight mask arrangement having at least two mask components comprising at least two wide elastic bands of constant width, the said components having at least one readily removable affixation means, the mask arrangement delimiting a defined unmasked area of a subject individual having a swimsuit form by masking limits thereof for body applications while at the same time enabling easy removal without disturbing an adjacent freshly treated area.

2. The body stencil system of claim 1, wherein the mask arrangement is sized to fit a particular portion of the torso or an appendage of the subject individual, and masks the defined area of the subject individual, delineating the unmasked area, to enable an applicator to leave a coverage substance such as body paint, tanning lotion, sunblock, spray-on fabric or spray-on bandages, only on an unmasked area of the skin of the subject individual when the mask arrangement is removed, the unmasked area facilitating leaving a pattern design on the subject individual.

3. The body stencil system of claim 1, wherein the mask arrangement delimits a logo or other form such as a swimsuit form on a wrist or ankle or upper torso, forehead, or a bathing suit area of the subject individual.

4. The body stencil system of claim 1, wherein the readily removable affixation means is selected from one of a group of affixation means consisting of an adhesive, adhesive tape, a zipper, a clasp, VELCRO™-type loop, hook strips, leaning into the stencil, and applying pressure between the stencil and the subject individual, and other interlocking overlapping portions.

5. The body stencil system of claim 1, wherein the mask arrangement includes a mask component or components for masking the thighs, the waist, the lower chest area and upper chest area, for example, with mask panels at least one of which has affixation means that permit easy removal once the basic application is complete.

6. The body stencil system of claim 1, wherein the mask arrangement comprises one or more stencils delimiting a pattern design, at least one stencil comprising a matrix of positioned bridging elements across the pattern design that permit the coverage substance to be applied below the bridging element, onto the skin in an area of the pattern design, the elasticity being selected to minimize deformation of the pattern design when stretched.

7. The system of claim 6 in which the bridging elements are raised from one or more skin surfaces, each respective bridging element spanning the delimited area of the stencil.

8. The system of claim 7 in which at least of portion of at least one stencil, in particular that which extends from an edge delimiting the pattern design outwardly adjacent a major surface of the stencil to reinforce said edge against deformation when stretched, is made from a material that is less flexible than a material from which the remainder of the stencil is constructed, thereby substantially preventing deformation of the pattern design when stretched.

9. A body stencil kit comprising the body stencil system of claim 1 and at least one paint application device such as a spray can of coverage substance, a brush, sponge, paint roller and roller pan.

10. A body stencil kit including the body stencil system of claim 1, further including at least one coverage substance and instructions for use.

11. The body stencil kit of claim 10, wherein the kit further includes detail stencils for applying further detailing such as flowers, stars, or logos over the basic pattern design or over otherwise untreated areas and optionally further includes an application tool such as a spray can of coverage substance, a sponge, a brush, paint roller and roller pan.

12. A method for applying a pattern design to an epidermal surface, the method comprising the steps of:
(a) applying a stencil arrangement having a pattern design delimited thereby on an appendage of a subject individual, thus leaving exposed an area defining an application pattern on the epidermal surface, the stencil arrangement further comprising at least one removable interlocking overlapping panel having an interlocking device thereon, enabling easy removal of the panel, the stencil arrangement itself providing an opaque essentially non-absorbent layer which protects the underlying epidermal area from overspray of an applied substance;
(b) applying a substance to the area of the delimited application pattern thereby covering the application pattern with the substance to cause the substance to contact the epidermal surface only in the delimited area of the masked by the stencil system;
(c) allowing the substance to dry; and
(d) removing the stencil system from the subject individual, thereby leaving the pattern design.

13. The method of claim 12, wherein the substance comprises a henna-based die.

14. A method for applying a pattern design to an epidermal surface, the method comprising the steps of:
a. applying a stencil arrangement having a pattern design delineated thereby and defining further an epidermal application area around or adjacent an appendage of a subject individual, masking thereby a predetermined area of the epidermis, the stencil arrangement comprising at least one removable interlocking overlapping panel for enabling easy removal of the panel of the stencil arrangement, the stencil itself providing an opaque essentially non-absorbent layer which protects the underlying epidermal area from an applied substance;
b. covering the epidermal application area with a predetermined amount of an epidermal treatment material to cause the material to contact the epidermis only via the pattern design masked by the stencil;
c. allowing the substance to dry, a portion of the substance covering the portion of the epidermis that is coextensive with the pattern design masked by the stencil to form a pattern design; and
d. removing the stencil from the subject individual, thereby leaving the pattern design.

15. The method of claim 14, wherein the pattern design is applied using at least an application device selected from one of a group of application devices consisting of a paint roller, a brush, and a sponge to avoid overspray.
